(19) United States
(12) Patent Application Publication
(10) Pub. No.: US 2003/0130975 A1
(43) Pub. Date: Jul. 10, 2003

(54) Decision-support system for system performance management

(76) Inventor: Carole Muller, Nimes (FR)

Correspondence Address: SCHNADER HARRISON SEGAL & LEWIS, LLP, 1600 MARKET STREET, SUITE 3600, PHILADELPHIA, PA, 19103

(21) Appl. No.: 10/182,287

(22) PCT Filed: Jan. 26, 2001
(86) PCT No.: PCT/IB01/00132

(30) Foreign Application Priority Data
Jan. 27, 2000 (DK) PA 2000 00139

(51) Int. Cl. G06N 5/02; G06F 17/00

(52) U.S. Cl. 706/50

(57) ABSTRACT

This method relates to the analysis in the performances of a system, whether economic or non-economic. The method by applying a specifically developed model isolates the components driving the dynamics of change over time or across locations. It may be used to analyse change, to monitor a pre-selected course or to project different potential scenarios in temporal analysis or in cross-comparison between locations. Besides its applications as a rapid assessment tool and as a management and strategic tool, it is also useful for data reengineering and in the predesign phase of complex analytical studies.

The present invention relates to the analysis of the performance of a system in order to monitor system performances and/or project different scenarios of expected system performances and/or compare system performance between across time or between locations for recording performances. By system is understood any way of purchase, procurement, sales, production or other transformation of resources or consumption of resources that can be listed in the form of a volume of resources transformed or produced or transacted or traded with a value per unit of volume and a value for the total volume. The invention comprises an analysis to determine the characteristics of the performance of the system and indicators for revealing the findings of the analysis and these indicators can be used for further analysis of another kind like statistical data processing of the indicator values and/or for predicting future development, for evaluating the impact of possible action to take to address future performance, and for monitoring the course of evolution and comparing it to a chosen course in order to follow and assess deviations from the chosen course. The performance is measured as items transacted or transformed, either as a flow in items (covering all items transacted or transformed during a period of time) or as a status record at a given time (a measurement recording the value or level of items at a given time. A flow may be both a flow (a flow could be a transformation or production or transaction or procurement or sale or consumption) of concrete products typically products that can be stocked) or it may be a flow in the delivery of services that cannot be stocked but are recorded as they are “during or following consumption” e.g. hospital beds in specific departments of a hospital. Typically a flow in the delivery of services is defined as the utilisation of a given capacity and is physically linked to this capacity (bed days in a hospital department can only be delivered in location to the beds of the given department), whereas a flow of products is defined as goods that can be detached from the production surroundings (dairy products produced from the dairy and distributed through wholesalers to resellers are to be found on the shelves of the shops or in the home of the consumers having purchased them. A third type of measurement might be part of a flow but could consist in isolated measurements like for example the concentration of CO in the air at a given location as a result of polluting gasses emitted by vehicles passing by. The same overall conditions apply to all flows or to status measurements and in all circumstances, it is highly desirable to be able to analyse the flow thereof, to compare it to the flow recorded in other places or to compare it to the flow recorded at other periods of time in order to e.g. obtain a better basis for decision-making of any kind related to the assessment of performances of technical and/or economic nature and to improve the management of resources and the achievement of goals set for an organisation (or company). The basis for such analysis is to achieve an insight into the characteristics of changes in a flow or similar to a flow status measurements in order to trace the causes impacting on the evolution and to better address how to act in order to direct performance according to expected or desired results and manage resources and control or pre-empt events accordingly.

In a similar way, the same method can be used to analyse the activity of a department inside an organisation, to analyse the whole organisation, or a whole market. A market can be defined geographically like a region or country or can be defined as an industry-specific market across different geographical localities. A market can be a segment of a broader market (like the market for penicillin is part of the wider market of antibiotics which in its turn again is part of the market for pharmaceuticals, and the market for original-brand injectable penicillin is a segment of the market of penicillin). This is relevant when a decision-maker wants to measure own performance (of the department or of the organisation or of the performance of one of its products against the whole product line) against a general reference, in the case of sales the performance of the whole market or for an outsider assessing markets and their potential and performing an analysis of all players on the market, the concept of a market being that of a sphere defined in time and place, where given products or services are being exchanged, either through direct buying and selling or provided and indirectly financed through some third party financing scheme. The method is applicable also to solving problems outside of a market set-up like for instance in the case of defining characteristics driving changes in the concentration of CO gasses emitted in given areas and in the context of urban planning and pollution control. The method is applicable to all areas where a resource management and performance problem can be analysed in the form of analysing and comprehending the causes for changes in a performance where the performance could be the cost of resources purchased by for example a procurement department and whether the change was driven by different acquisition patterns, or higher volumes acquired or higher cost prices per unit or which combination of any or all, or the sales figures achieved vy a seller or a sales department or store and whether the performance change was attributable likewise to higher volumes transacted or to price formation/pricing issues or to shifting sales patterns attributable to supply side effect like active promotion or to demand side effects like shifting needs, or in a production set-up it would be applicable to studying industrial efficiency and the transformation efficiency of production factors into a given production of goods or services or more immaterial output like locomotion+gasses as the resulting output of fuel burning) in order to identify the given combinations of trade-off between volume and quality/price of factor units and/or composition and mix of factors entering the production/transformation process.

When assessing performance a main concern is to produce analytical results that will allow to relate the performance recorded to a reference, either a baseline reference originated from an initial start value in time or a reference for comparison from different records (comparing the performance of entities located differently or comparing the performance of an entity across time) or a reference for comparison that is virtual, like comparing actual performance with desired or expected development and policy goals where such a desired or expected development could be defined by using the indicators provided by the method or could be defined by other ways in terms of a quantitative or qualitative definition. The data available defines the scope of the analysis, and the method is adapted to this scope.

In a first aspect, the present invention relates to a method of analysing item flows, or analysing records in points of time of a given observed total value level (like the level of CO gas in the air at a given time of the day, or like the sales every first of the month) the relation between flows and records in time being that many, or continuous records in time constitute a flow, the method comprising:

1) defining a first period of time starting at a first point in time and ending at a third point in time,

2) defining a second period of time starting at a fifth point in time and ending at a seventh point in time,

3) defining a group of items, identifying individual items, i, within the group,

4) defining the appropriate units for determining the volume flowing of i during the observation time, defining the appropriate units for determining the value per unit of i flowing during the observation time, which will be the basis for recording or calculating the value of the flow of i being transacted or transformed (or consumed) or produced during the observation period,

4) defining a first market or location wherein the flow of the items, i, is analysed during the first period of time,

5) defining a second market or location wherein the flow of the items, i, is analysed during the second period of time,

6) determining, for each identified item, i, a first volume, qᵢ₀, and/or a transacted/transformed value in monetary terms, yᵢ₀, transacted in the first market (at the first location) and during the first period of time,

7) determining, for each identified item, i, a second volume, qᵢ₁), and/or a transacted/transformed value in monetary terms, yᵢ₁, transacted in the second market (at the second location) and during the second period of time,

8) determining, for each identified item, i, a price, pᵢ₀), or more generally a value per unit thereof in the first market (location) and within the first period of time,

9) determining, for each identified item, i, a price, pᵢ₁ or more generally a value per unit thereof in the second market (location) and within the second period of time,

10) determining whether items i are purchased, sold, transacted, transformed, produced or consumed independently of each other or

11) determining whether such a dependency or relation may be established and then defining this relation in the form of a specific bundle of i leading to a given type of Y, for example for Y being a hospital emergency room intervention for an asthma attack a given procedure requiring available oxygen and given drugs of choice will be followed with a given set of examinations and blood gasses lab test thereby defining for most average cases a bundle of resources i described by a vector of several xᵢ applicable to the diagnose category diagnose(Y) into which the number of patients admitted and ultimately the costs are entered and will figure in a performance Y(acute asthma attack)=costs incurred by all patients treated for acute asthma attack during a given period and at a given emergency room.

12) providing information, Y₀, relating to a total value in monetary terms of the transaction or transformation or consumption of items, i, in the first market or location and during the first period of time,

13) providing information, Y₁, relating to a total a total value in monetary terms of the transaction or transformation or consumption of items, i, in the second market or location and during the second period of time,

12) providing information measuring or describing a difference, ΔY, in the transacted value for all items, i, from the first market(first location) during the first period of time to the second market(second location) during the second period of time,

13) providing information describing a difference, ΔQ, in a transacted volume for all items, i, from the first market(location) during the first period of time to the second market (location)during the second period of time,

14) estimating, on the basis of the determined pᵢ₀, pᵢ₁ and qᵢ₀, qᵢ₁, and/or yᵢ₀ and yᵢ₁, information, ΔP, describing a part of Y₁ which, compared to Y₀, stems from differences in prices or in unit value of the items, i, from the first market (location) and during the first period of time to the second market (location) and during the second period of time,

15) providing to a user information relating to a difference between ΔY and a sum of ΔQ and ΔP.

It has become clear to the present inventor that the difference ΔY normally stems not merely from a difference in prices or unit values at the level of items i or from differences in the volumes transacted, transformed or consumed of items i but that there is additional information to be collected and used in an analysis of the item flow (or in the analysis of the value observed at a given point of time in the general level of items e.g. the level of total CO gas emissions recorded as observed at a given time)

In the present context, a group of items may be defined in any desired manner, depending on whether the scope of the analysis is internal to the company/organisation or external involving a company/organisation or a group of companies/organisations compared to the whole market or to a group of companies/organisations, another case being the comparison of observations not related to a company or organisational set-up like comparing the level of total CO gas emissions in a given street as compared to another street or another city or locality.

Normally a group of items would be those items on the relevant market (location) with which a predetermined product competes. However, similar products or other products which are considered to have or expected to get e.g. the same effect, potential or features may also be included in the group. In this context, it may be desired to also include within the group items having e.g. different contents—especially if the individual units therein would compete directly with the predetermined item. It may also be preferred to define as the group all items being within the same overall group of items—such as e.g. milk products or pharmaceuticals intended against hypertension. Finally a group of items may be composed of a “basket” of seemingly unrelated products—as long as it makes sense to the operator. For example such a basket could consist of the top ten percent best sellers during a sales, to compare what are best sellers from season to season or from point-of-sales to point-of-sales.

Grouping items would be different if the analysis is internal to a company/organisation, as the grouping might derive from a predetermined categorisation of items. The method may however be applied in such a way as to redefine groups if this makes more sense to the operator or to the user of the analysis. Redefining groups would be useful to determine the causes for changes in performance when more than one item i is involved in the performance and grouping items might take place in the simplest of way like redesigning a database structure or applying redefinitions of groups across an existing database structure. Grouping of items can also take place in the form of designing complex bundles of i that are used to calculate a composite result for the value of x(i) for p(i) and q(i) or entered as a vector and the method is adaptable to the case of complex bundles. For example a department store might group items according to product categories and departments, while the method might be applicable across the organisation/the store assessing the performance of for example of for the all products with environmental friendly labels of quality versus standard products. In this case a redefinition of groups across existing databases or designing another database for the analysis would offer the grouping options required. In the context of a complex service delivery or production or transformation a bundle of items i would be involved and should preferably be defined giving the analyst and the user the option to calculate and apply the method at item level or at bundle level where the bundle could associate items of different accounting and volume units by aggregating the items using weights or other rating methods depending on what makes sense to the user in the context of the analysis to perform with the method and further. The method is adaptable to performing the analysis at item level or at group level or for a grand total or for composite bundles aggregated by way of a preferred method relevant to the context.

Grouping items in the context of a production or transformation of items, e.g. the production of hospital services and the transformation occurring when vehicles burn fuel and produce locomotion and gasses would in general be different from grouping items in a market context, as production logics might or might not necessitate certain grouping within or across departments, while transformation characteristics might require grouping all vehicles by functionality or other criteria like grouping those burning diesel oil together and all vehicles burning gas oil together, with vehicles powered by electricity grouped together.

At item level, there is no smaller entity to be isolated and defined and for which information and observations might be recorded. An item is the basic record and items can be grouped with totals added up at group level for the volume or for the value of the total volume of items transacted, transformed, produced or consumed as defined by bundle of items making up this particular group. Groups can be further added one another until one reaches the grand total of the department, the organisation the market or the location being surveyed. For example total sales of a chain store can be split up into sales of food and non-food and further on to food off the shelf, food from the delicacy counter, dairy, meat and so on.

Identifying individual items within the group may comprise all identifiable characteristics describing items falling within the definition of the group. Alternatively, it may be desired to merely identify part of the identifiable items—such as based on additional criteria, such as the manufacturer of the items or the barcode of the product. These or other selection criteria would then create a new group (subgroup) containing elements of the original group.

In the present context, the term “market” should be considered as broadly as at all possible in that it is defined as a sphere delimited in time and place in which given products and services are made available for buying and selling, for transformation (like in a production process where raw paper mass is transformed into paper for the printing industry) for production or service delivery or consumption (like for hospital delivery services). The term “markets” will also include markets where the transaction between provide and recipient involves a third party for requesting and/or fourth party for financing for example where the institutional set-up allows for the supply of goods and services that are provided to the demand side through third-party financing like provision of health care and other services provided to patients or to users through insurance-based or tax-based financing schemes and by way of or without an agency relationship. Sometimes the set-up is even involving a fourth player in the form of an organisation requesting the services or assembling a service package like a Health Maintenance Organisation. For example doctors working for an insurance-based service provider who are prescribing an operation and referring the patient for operation in a private clinic with which the service provider has entered into a care-provider agreement, are on behalf of the patient, acting through the agency-role to demand specialised health care funded by third-party financing like an insurance, HMO or public sector (provision) funding in part or totally the private clinic or the service provider delivering the service. The doctor prescribing the operation, the insurance signing up patients for a health service package, the public sector funding or the company funding the package for the patient all have different definitions of what is a resource and what is a cost and what is a performance for the same problem solved in the same context. The method is applicable by the players involved however the performance and results to assess and monitor or the desired evolution will most certainly be different for each player.

The method is also applicable outside of what can be defined as a market in the context of monitoring events or results less tangible than goods or services, like when monitoring signal emission to analyse emission patterns or when analysing gas emission resulting from fuel consumption like in the case of authorities or other bodies wanting to assess and comprehend determinants of urban pollution by following the concentration of CO gasses emitted by vehicles when transiting through an area and burning fuel and by analysing the characteristics driving the dynamic pattern in changing CO concentrations in the air.

Normally, a volume will relate to a number of transacted units of a certain item and to the volume contents for such a unit. Volume contents per unit multiplied to the number of units per item gives the volume contents of each item, and this is preferably measured in a relevant scale unit like kilo (pounds), meter (yard), kilo meter (miles), sqm (sqf) man hours, bed days, vehicles or tonnage passing.

The performance can be expressed in monetary terms or in non-monetary terms. For any flow of items measurable in money terms a turnover in monetary terms or the value of the transacted volume in monetary terms expresses the value in money terms of the volume measured as described above, and once this volume has been attributed an item price, the turnover in monetary terms is the total volume that was exchanged on the market for any given item multiplied by the item price. Measuring the turnover in physical volume units as well as in monetary terms is relevant whenever price change occurred either due to actual changes in the price of an item or more indirectly due to for example currency adjustments. A volume of 1000 items sold for 12$ per item has another value in monetary terms for say the German subsidiary of an international company, when resold in Germany after an increase in the dollar rate, even though the company listed price, 12$ does not change. The value in monetary terms of the transacted volume of 1000 units with an unchanged listed price 12$ will be affected upwards, when transacted volumes (here in the relevant currency, DM) are made up in money terms.

A turnover or the value of the transacted or transformed volume may also be measured in non-monetary terms where the context lends itself to analysing observations that are not of monetary nature. For example when analysing the emission of CO gasses, the transformation is from fuel to (energy used for transport and) gasses. The observed record for the transformation could be the CO gasses and the volume unit used to monitor the impact of volume on performance might be the tonnage of the traffic passing, or the number of vehicles differentiated into different categories or not, while the unit value (the “price”) could be the average transformation rate of fuel, e.g. fuel burned per kilometre typical of given classes or models of vehicles, so that total emissions of gasses would be due to the volume of traffic and the type of vehicles (the value of the transformation of fuel per unit of distance and/or in time when burning fuel without moving) with an expected or theoretical performance and a real or observed performance thereby allowing decision-makers to enter other determinants like the background pollution level or the estimated impact of maintenance on fuel transformation.

In the context of a production of goods or a delivery of services with or without onsite consumption a typical model would be to record the total output (the total of bed days produced) and the price being the input of resources used to produce such a bed day, typically made of a list of resources like nursing resources, medical diagnostic resources, medical therapeutic resources, surgery and other intervention resources, lab resources, catering and hotel functions etc . . . . It is clear that the price could be a simple unit value (the total cost per bed day) or could be further split into its components (the price of each resource or group of resource listed) like mentioned above depending on whether the items considered would be considered on a single basis or bundled into a composite expression.

It should be noted that an item, in the present context, represents an element fit for recording as a basic unit, the number of which will be counted and accounted for in the records kept relating to the performance. There is ample variation in what could be an item and the basic unit depending on the recording systems and data collection systems preferred by organisations and depending also on the current logic or traditional views relevant to the context of the analysis. Such an element could be man hours to record the Human Resources very often used in the context of projects or in certain professions to relate to a given performance or it could be days or months of employment, depending on as well the record keeping of the organisation or the data available and collectable and depending also on the logical needs for the data to be recorded. An element in a market context would be marketable volume fit to be offered and justly and lawfully sold or bought or provided freely to the demand side. Such an element or item might be apples sold per kilo in a green grocer or apples sold in packaged 5-kilo plastic bags in a supermarket or at the location of the wholesaler it would probably be apples in wooden boxes of 20 kilo. An item represents a whole acquired as such for any current and formal value or packaging accepted and in use in the system being analysed. An item will for example be a package of biscuits or a in a hospital context could be a bed day produced or an “admittance for diagnose X” produced or a lab test for blood-cholesterol contents or man-hours entering into staffing the emergency ward. An item could be a single packet of 20 cigarettes in a shop or a carton of 10 such packets at the duty-free or wholesaler as it might be a single cigar purchased in the after-dinner lounge of a restaurant. An item could be a vehicle passing through a given location when analysing urban pollution or it could be the number of business passenger seats and tourist class passenger seats in a plane when analysing air company sales. What is relevant is the form and the quantity under which the item was recorded as constituting the unit of records. This form and quantity could be the form and quantity packaged and transacted as the least unit sold to the purchaser. The quantity packaged naturally will influence on e.g. the price of the item. Also, the price of the item may be a normal sales price thereof, the listed price, or a discounted transaction price, where the discount was due to some on the spot due to sales or preferential customer advantage or other benefit, like bulk discount.

More generally as for example in another context than the market context, the item would be the least unit at which records might be obtained and are obtained. For example in the context of pollution monitoring it would be each single vehicle entering a confined area under observation and the type of vehicle and its characteristics would be the features allowing to group or regroup items for analysis and cross-comparisons. With total gasses of CO observed and recorded (reflecting the total value of fuel “transformed” into “pollution”) and with the average unit value for fuel transformation know for each vehicle (the unit value or the “price” to the environment of locomotion or of transforming fuel into transport), different analysis would be possible, like monitoring the general maintenance level of the vehicles and how it affects the rate of emissions in a locality as compared to what could be expected ideally, the effect of traffic congestion on pollution levels u (measuring the changes in CO gasses recorded when traffic congestion at a given point renders the flow of traffic slower through given perimeters), the same measured under different climatic conditions to assess the impact of climate on pollution in a given locality, the effect on pollution levels of given remedies, like redirecting traffic at certain hours, imposing filters and other devices to be installed etc . . .

Preferably, step 15) comprises:

estimating, on the basis of the determined pᵢ₀, pᵢ₁ and qᵢ₀, qᵢ₁, and/or yᵢ₀ and yᵢ₁, information, ΔX, describing which part of Y₁, compared to Y₀, stems from a difference in the relative composition of Y as defined by the relative share of each individual item, i, from the first market (first location) and during the first period of time to the second market(second location) and during the second period of time.

Compared to the step 14), it is now clear that the difference between turnover or produced or transacted or transformed value (Y₁ and Y₀) may stem from not only a difference in the price (or in the unit value) or in the transacted or transformed or purchased volume of individual items but also from what may be termed as a difference in the mix of items transacted—or a change in the preferences of the transactors (customers, clients, users, . . . ) in the market(s) and as expressed by the purchasing or transformation or consumption or utilisation patterns, this change in the relative constitution of the bundle of items entering into Y₁ affecting the total value that is transacted or transformed or consumed and recorded as Y_{1,} and in such a way as to make it different from Y_{0.}

Normally, step 12) would comprise determining ΔY as:

$$Δ Y = \frac{{Y}_{1} - {Y}_{0}}{{Y}_{0}}$$

where Y is the sum of the y of all i comprised in a group, subgroup or grand total.

Also step 13) would normally comprise determining ΔQ as

$$Δ Q = \frac{{Q}_{1} - {Q}_{0}}{{Q}_{0}}$$

where Q₀ is the sum of all qᵢ₀ and Q₁ is the sum of all qᵢ₁ normally defined for the same group, subgroup or grand total as for which Y is defined.

In general, two methods exist for the determination of ΔP in step 14). A first method is one where for the values available for t⁰ and for t¹ using the unit value p of item i available for period i t⁰ and for period t¹ ΔP is determined as ΔPₐ:

$$\begin{matrix}Δ {P}_{a} = \sum \frac{{p}_{i1} - {p}_{i0}}{{p}_{i0}} * {w}_{ai} \\ where {w}_{ai} = \frac{{q}_{i0}}{\sum {q}_{i0}}\end{matrix}$$

Another method is to determine ΔP as ΔPₚ:

$$\begin{matrix}Δ {P}_{p} = \sum \frac{{p}_{i1} - {p}_{i0}}{{p}_{i0}} * {w}_{pi} \\ where {w}_{pi} = \frac{{q}_{i1}}{\sum {q}_{i1}}\end{matrix}$$

Naturally, the quality of the analysis of the item flow will depend on the quality and the nature of the data collected and entered into the analysis. One example is that where the volume and turnover (transacted or transformed value) of a given item is determined during a period of time wherein the price (unit value) of the item has varied more than just slightly. If data related to this variation in price are not taken into account, the analysis would normally not provide results with the same degree of truthfulness as if it was.

Thus, preferably steps 6) and 8) comprise the steps of:

a) initially, at the first point in time, determining a price (or value per unit) for each identified item, i,

b) subsequently, at one or more second points in time when a change in the group occurs consisting of:

when a price (value per unit) of an item, i, changes,

when one of the items, i, is removed from the group,

when a new identified item, i, is introduced into the group,

when one of the items, i, is removed from the first market (location) and made unavailable, and

when a new identified item, i, is introduced onto the first market (location) and made available, or

when specifications are changed, such as product/item contents, quality, look, taste, usage, administration, standards, (leading to or not leading to a product exit or product re-entry, this would normally depend on legislative market regulations),

b1) determining a price (unit value) for all identified items, i, after the change,

b2) determining a turnover (transacted or consumed or transformed value) for each identified item, i, in the period from a previous second point in time or the first point in time to the actual, second point in time,

c) subsequent to step b) and at the third point in time, determining a price (unit value for i) for all identified items, i, and a turnover (transacted or consumed or transformed value) for each identified item, i, on the period from the last second point in time to the third point in time.

In addition, preferably steps 7) and 9) comprise the steps of:

a) initially, at the fifth point in time, determining a price (unit value) for each identified item, i,

b) subsequently, at one or more sixth points in time when a change in the group occurs consisting of:

when a price (unit value) of an item, i, changes,

when one of the items, i, is removed from the group,

when a new identified item, i, is introduced into the group,

when one of the items, i, is removed from the first and/or second market (location) and is not available, and

when a new identified item, i, is introduced onto the first/and or second market (location)and is made available, or

when specifications are changed, such as product contents, quality, look, taste, usage, administration, standards, (leading to or not leading to a product exit or product re-entry, this would normally depend on legislative market regulations),

b1) determining a price or a unit value for all identified items, i, after the change,

b2) determining a turnover value or transacted or transformed or consumed value for each identified item, i, in the period from a previous sixth point in time or the fifth point in time to the actual, sixth point in time,

c) subsequent to step b) and at the seventh point in time, determining a price or a unit value for all identified items, i, and a turnover value ( or transacted or transformed or consumed value) for each identified item, i, on the period from the last sixth point in time to the seventh point in time.

Also, in that situation, the method preferably further comprises the step of: at each second and/or sixth point in time as well as at the third and seventh points in time determining the parameters:

ΔY, ΔQ, ΔP, ΔX,

and

υ=ΔY−ΔP−ΔQ−ΔX.

There are several ways by which an item may exit and re-enter the context of the analysis seemingly under a different set of item characteristics and therefore altering the way in which this item impacts on performance. The method is adaptable to such exit and re-entry phenomena and is useful also in taking this bias into consideration when assessing performance as such a phenomena of exit and re-entry often goes unrecorded because of unaccounted for change or it goes unnoticed because it is the result of elusive behaviour, in both ways it creates an environment of change that can be unforeseen and unrecorded whereas the method will assist the user in pointing to this change and locating some of the origins when traceable. In the present situation, the removing of an item from a market or a group in order to re-introduce it immediately after or after a period of time with different specifications (such as different numbers of units therein, different concentration of an active ingredient, different colour, taste, shape, intended use, manner of administration, product standard) will be seen as a removal from the market or group and re-introduction of a new item into the market and/or group. Marketing may employ these techniques to perform unrecorded price changes and affect price formation in ways eluding the knowledge of competitors or of organisations responsible for price watch or price control. Another change, which should be monitored, is one where the product is perceived differently by the market. A situation of that type may be that where a given dairy product from the company Danone was distributed and sold in Denmark for many years and following this was one day re-classified in the official statistics and product encoding thereby exiting the category of milk products and entering the category of desserts. This brought quite some focus and attention to the relatively high fat contents of that product, its high level of additives and food colourings and high sugar contents, thereby creating unwanted PR and awareness in diet-conscious consumers, which impacted on performance by affecting sales significantly as the product had been much appreciated and bought by parents for years as a nutritious children's “healthy” dairy treat, (the result of a careful marketing campaign and image branding) and with nobody checking the calories and composition for years, the product suddenly suffered a loss of image when consumers became aware of the composition and rejected the product as a children's treat where it had positioned itself for years and as a dessert. Changes of that type may directly or indirectly bring about abrupt changes in the market. Similar examples exist to illustrate abrupt changes in the performance of transformation processes outside of market set-up when the quality of one of the input factors changes, like the abrupt changes, costs inflicted and painful consequences not quantifiable in monetary terms for patients having undergone surgery and having received blood transfusion or having being treated with blood products contaminated with AIDS and further during the period after the story came out but when most countries continued using AIDS contaminated blood products for instance like coagulation factor used to treat haemophiliacs based on old blood production while screening only new blood donors and warming blood transfusion products so a pool of contaminated products was delivered and used with users (operators) and end users (patients) believing that the necessary measures were applied. The consequence being here that performance and costs at hospital level (the organisation are directly increased by a loss of quality caused by the increase in a related side-effect (the spread of AIDS through contaminated blood products) just as society costs increased due to the trials and compensation as well as treatment of the patients infected during treatment for unrelated illnesses. Such abrupt change imparted on performance were induced—apart from the trial and compensation costs—by a necessary investment in changed procedures and were caused by changes in the transformation process and in the quality of items entering the transformation process.

Using the preferred data collecting method mentioned previously, high quality data are provided, which form the basis for a high quality analysis.

An alternative manner of obtaining high quality data would be to not collect the flow data or stock data at points in time where specific events or actions occur but instead simply to perform the data collection with small intervals of time in order to reduce the effect of “missing” a change in the market.

There exist a number of manners of determining or estimating ΔX of which the simplest is:

ΔX=ΔY−ΔQ−ΔP.

Another manner is to calculate ΔX as

$$\begin{matrix}Δ Xa = \frac{( \sum {w}_{ai} * {Y}_{1} * {p}_{i1} ) - {Y}_{1}}{{Y}_{1}} \\ where {w}_{ai} = \frac{{q}_{i0}}{\sum {q}_{i0}}\end{matrix}$$

A further manner is to calculate ΔX as

$$\begin{matrix}Δ Xp = \frac{( \sum {w}_{pi} * {Y}_{0} * pi0 ) - {Y}_{0}}{{Y}_{0}} \\ where {w}_{pi} = \frac{{q}_{i1}}{\sum {q}_{i1}}\end{matrix}$$

and where the indices attached to variables being 1 and 0 stand 1 for the values available for period t₁ and 0 for values available at period t₀

As mentioned previously above, numerous manners exist for defining the group. Preferably, step 3) comprises defining a group of items and further defining one or more subgroups of items, where the items of the subgroups are comprised within the group of items. In this manner, it may be possible to analyse each group and subgroup independently of the other. The same is applicable in the case of defining a specific bundle, complex and composite or not, and comparing bundles to a grand total or to each other or to one of the groups derived from the natural data hierarchy as set by the data collection and data storage.

Thus, in order to again obtain high quality data, preferably steps 10)-15) comprise providing, for both the group or the bundle as well as any subgroups, the information Y₀ and Y₁ and the information describing the differences ΔY and ΔQ as well as estimating the information, ΔP and providing the information related to a difference between ΔY and the sum of ΔQ and ΔP.

Step 3) may comprise defining the group or one or more subgroups of items as (a) group(s) of items having in common:

the brand of the items,

the intended use of the items,

the contents of the items,

the same class and/or subclass in a standard global classification system for products and services e.g. OTC,

the country of origin or manufacture of the items,

the region of origin or manufacture of the items,

the same producer/manufacturer/importer/exporter/retailer/wholesaler,

criteria for selecting groups of individuals like

demographic and socioeconomic or other data when analysing the

performance of services consumed by these individuals or

purpose of intended use

criteria for defining the conditions of supply, provision and delivery of services like

the type of tests performed for a given patient diagnose, the name of the

doctors or surgery team intervening, etc . . .

and/or any criteria meaningful to the analysis and collected in the data, and present as a dimension in the data set submitted for analysis.

Also or alternatively, step 3) may comprise defining a group or subgroup of items as items having in common:

the same number of units in a packing,

the same concentration of an active ingredient,

the same colour,

the same taste,

the same shape,

the same product standard, any criteria meaningful to the analysis and collected in the data, and present as a dimension in the data set submitted for analysis.

It is clear that if ΔP≠0, changes in prices can be expected to be responsible for at least part of the difference between Y₁ and Y₀. However ΔP≠0 is a particular case as ΔP, being a calculated variable, is particular to handle at the interpretation of results. In the event that ΔP≠0, and depending at which level of group in the data hierarchy the analysis was performed for, further analysis is needed to investigate whether ΔP truly is ≠0, or whether different trends at item level or at more significantly at group level cancel out each other. The method is then applicable at different levels, splitting up the group for which ΔP≠0 into subgroups or assessing the changes in p at the level of i in order to check out the possibility of hidden trends cancelling each other. Thus, it may be desirable to inform a user or operator of the present analysis thereof as the method also provides access to checking out the validity of ΔP≠0.

Also, if ΔQ≠0, changes in volumes were responsible for at least part of the difference between Y₁ and Y₀, and it may be desirable to inform a user or operator of the present analysis thereof.

Also, if ΔX≠0, the inventor has realised that changes in the demand or in the transformation or utilisation or consumption patterns were responsible for at least part of the difference between Y₁ and Y₀. Thus, it may be desirable to inform a user or operator of the present analysis of that fact.

In the present invention, a flow of items is analysed during a first and a second period of time and in a first and a second market(location) or alternatively and instead of a flow of items what is analysed are the recorded levels in a given variable observed at a first and a second observation time and in a first and a second or in location (that could be identical locations) e.g. the recorded level of CO gas concentration in the air observed at a given time in two different locations or at a given time and again repeated at another given time and compared. The first and second periods of time may be at least substantially coinciding or identical (the first and fifth points in time and the third and seventh points in time being pair-wise identical or at least substantially identical) if the markets (locations) are not identical.

Alternatively, the markets (locations) may be at least identical, whereby the first and second periods in time are not identical or coinciding. The first and second periods in time may be subsequent or not. Preferably, in this situation, the first and second periods in time have no overlap—and most preferably, the fifth and the third points in time are at least substantially coincident. Alternatively, overlapping periods of time may be used preferably only in the analysis and not in the recording of data in order to e.g. use a moving average.

In yet another aspect, the invention relates to a method of simulating the item flow (or simulating the observed level in a given variable indicating a level to monitor), the method comprising performing the above method for analysing data but where steps 6)-9), instead of relating to real, determined data, comprise providing expected future prices (values per unit) and volumes and/or turnover or transacted or transformed values. These expected future prices (values per unit) and volumes and/or turnovers may be real, determined prices (values per unit) and volumes and/or turnovers, transformed or transacted or consumed value, which are transformed to represent the expected future prices (values per unit) and volumes and/or turnover value or value transacted, transformed or consumed. Alternatively, these data may be fully fictional.

This manner of simulating an item flow (or fluctuations in a level to monitor) makes it possible for a decision maker being for example a market analyst, a manufacturer, a service provider, a merchant, an investor, a legislator or a controller to alter the data related to the items—such as the price (or the value per unit)—and to immediately forecast or estimate the effect thereto on the performances to be expected from the transformation or transaction or consumption or market process. Because ΔX is introduced, the method provides the decision-maker with at least three distinct comprehension and action parameters and thereby tools for making strategy operational and monitoring action, like target prices (threshold values per unit), volumes, product or resource or consumption mix, with which to impact on the market (or on the transformation process and its effect or on the transaction or on the utilisation of services or on the consumption) in order to achieve the goals of the company/organisation/authority, and the method allows for the measurement of the separate or combined effects of any of the three fundamental parameters.

Another use of the above analysis method is to add thereto a monitoring function which compares the determined, calculated or estimated (actual) results with a desired or expected development therefor. Thus, the analysis method preferably further comprises steps of:

establishing a desired or expected development for at least one of Y1, Y2, ΔX, ΔY, ΔP, and/or ΔQ, and/or any of these at item level like y₁, y₂, Δy, Δp, Δq, and

informing a user or operator if this development is not obtained and characterising by way of the indicators proposed by the method the extent to which and within which domain of the indicators the actual development departed or deviated from the expected development, whether in the domain of volumes, pricing or value per item or in the domain of the mix of items.

In this manner, strategies laid down for the products, services or consumption or transformation to take place and which are based on the desired development or which were expected to result in this development may be evaluated in real time and addressed or countervened at the very beginning of a deviation from this expected development.

Naturally, the obvious use of the present invention is to implement it in software. Therefore, the invention also relates to a computer system performing the above-mentioned methods, a computer program comprising computer program code means adapted to perform all the steps of the methods and preferably additional modules checking for example the data integrity and data coherence for the required analysis when said program is run on a computer, and that computer program embodied on a computer readable medium.

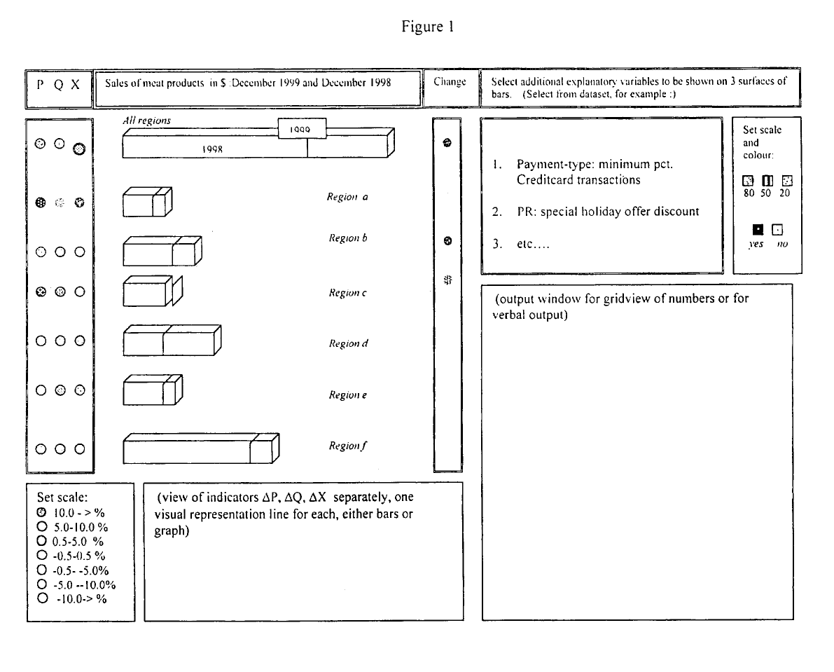

In the following, a preferred embodiment is described in relation to a product embodying this embodiment and with reference to the drawing wherein FIG. 1 illustrates a preferred manner of illustrating results of the analysis.

Further below, comparative calculations are performed to illustrate the method. Firstly, the variables used in the formulas are defined.

These Variables are Listed Below:

for any given time interval tₜ, and for any given item x defined as xᵢ, i being the identifying tag for the product type purchased or the resource type transformed (or service or output delivered) or other type of item selected from any given n, where n is a number from 1 to ∝, matching the number of items in the form of products/resources/services/types available and representing a merchandise or a product or a service or a resource output at the single unit level and most basic entity level recorded for observing performance and for which records are effectuated and available for analysis, the most preferred method entails using the most detailed basic level, like bar-code level for products available

The item range vector rₙ^{t}=(x₁, x₂, x₃ . . . , xₙ₋₁, xₙ), representing the whole range of n distinct resources or items available for transaction and listed exhaustively (items available for transaction or consumption or production or transformation or trade) during period t and for a number n comprised between 1 and ∞

The performance value (the turnover or transaction or transformation or consumption value measured in monetary terms or other relevant value term making it possible to size its total value) resulting from the process where the item xᵢ is entered:

yᵢ=y(xᵢ) where y(xᵢ)=p(xᵢ)*q(xᵢ) either by collecting data for p and q or by calculating p and q when applicable

The same for any given group or bundle Y consisting of one or more y(xᵢ) and that can be summed to that total: Y thereby it is clear that any Y may be split further in subgroups or may be entered as the subcomponent of another Y at a higher level of the data hierarchy.

The performance or output vector rₘ^{t} listing the definitions and or performance value of groups and subgroups or the logical bundles defined across the group/subgroup system to form any given Y during period t and for a number m of possible and identifiable Y's all different and unique, where m is a number comprised between 1 and ∞: rₘ^{t}=(Y₁, Y₂ . . . Yₘ ) and where this listing may comprise both groups exclusive of another and bundles across groups, so the sum of all elements in rₘ^{t} is not necessarily identical to the grand total performance Y for the organisation or market or location considered.

The relative difference in the transaction value of x between two time measurements of y: Δyᵢ(xᵢ)

The relative difference in the transaction value of an addition of several x (being the total at any group level or for any bundle of items in the turnover value measured in monetary terms or the transformed value measured in the relevant terms) between two time periods and as compared to the baseline value of Y: ΔY

The volume amount (in physical volume units) transacted of the item xᵢ:

qᵢ=q(xᵢ)

The total volume transacted for any given Y, adding up the q(xᵢ) being part of that total: Qᵢ

The relative difference in the volume amount transacted of xᵢ between two periods: Δq(xᵢ)

The relative difference in total volume transacted of any given total Y between two periods: ΔQ

The price or (the value for one unit transformed/the value per item) for an item: p(xᵢ)

The relative difference in prices in the value per item for any given item xᵢ between two time intervals: Δp(xᵢ)

The Indicator Variables Calculated by the Method are Listed Below:

The indicators indicate on any given Y compared to another Y the aggregated effects of differences (when comparing different locations) or changes (when comparing over time) impacting on Y and attributable to the distinct and separated effects as proposed by the method of changes in prices (item values) or in volume at the level of its elements xᵢ and a third type of indicator variable developed in this method introduces the effects on any Y chosen like above as compared to any other Y chosen as above of differences or changes in the composition of items leading to the Y being compared to the other Y:

The effect at the level of Y of the changes or differences in volume occurring for items or subgroups of Y: ΔQ

The effect at the level of Y of the changes or difference in prices occurring at item level or at group level for subgroups entered in Y: ΔP

The effect at the level of Y of the differences in the composition of Y or changes or differences in the relative composition made up of items or subgroups entering into Y: ΔX

and this indicator is here called the mix-indicator to designate the separate effect on Y of different product selection by purchasing customers or of different resource combination selected or utilised for transformation in the course of production or service delivery or other and less tangible production like turning fuel into transportation+pollution).

Flow Variables and Setting Period Length

The variables are of two kinds: static variables, dynamic variables, or stock variables (static) and (dynamic) flow variables, the relation being that a more continuous observation and record of data turns stock or status variables into flow variables, and that flow variables cumulate a value and changes incurred throughout time on this value while stock variables reflect a level in the value of the variable achieved in the context of a more discrete measurement and assessment. Records of the flow of goods and services, q(x) and Q, and of the transaction value of these, y and Y, are flow variables when dynamically changing and accumulating performance during a time horizon. For example “sales to date” recorded on a quarterly basis 0 will consist of sales recorded for the first quarter added to sales for the second quarter and sales for the third quarter and sales for the fourth quarter and will be a flow dynamically evolving with time. Sales for the first quarter of the year will by the first day of the second quarter or any day where the total is calculated following the end of the first quarter be a static variable just as the measurement of the concentration of CO gasses emitted on the first monday of the month. “Sales to date” will comprise the whole series of measurements effectuated at each point in time and may be further split into static values for each time unit selected and feasible by the data like sales per week or per month or even per hour. The method is applicable and adaptable to any of these types of variables depending on the data collection as the measure naturally cannot provide inexistent data records so the minimum time interval for which a time period may be defined and the assessment proposed by the method may be conducted is defined by measurements to be obtained. For example if measurements are available with a maximum frequency of recording set at the level of the hour this is the least time interval that may be used, but the user or the operator may prefer to set another time interval with a lower frequency that what is available depending on the capacity of the data processing system operating the method and depending on the desired level of accuracy and the expected impact on accuracy of setting longer time intervals, as the shortest the interval the higher the accuracy in principle but not always. Selecting the appropriate interval can be supported by a module guiding the operator or the user or by effectuating pilot tests with the method and comparing the resulting loss of information when changing the time interval parameter. In this sense the method is applicable also as a pre-analysis prior to analysing the whole data set consisting of more data groups or longer time horizon or as a pre-analysis prior to analysing the data with another method than the present method and where the pre-analysis is used to enhance the quality of the subsequent data analysis, structure its horizon and estimate the trade off between more accuracy, more complex results to interpret and higher analysis and interpretation costs.

Static records will be used when it makes sense to the operator or the user only to record at a given time, for example as in the case of the pollution control monitoring, the alternative being to monitor over a period and take an average figure. This is typical of situations where the performance to be assessed is a figure for the value in a given performance variable here and now. For other variables reflecting the evolution in the performances delivered over a time horizon, typically tangible performances as merchandise traded or goods and services produced delivered or consumed, at the end of a period the flow dynamically updated throughout the period is accumulated throughout that period and is ultimately when the period ends a (static) stock value recorded as per the period's interval end-point in time, reflecting the incremental value achieved throughout this period and thereby the increment concerning this period for a dynamically updated flow variable observed over a longer time horizon. By adding the incremental value to the cumulated incremental values recorded for each past period, and added to the initial start value of the variable a new flow variable is achieved measuring the cumulated effect of flow in the value of the variable over several time periods.

Calculated variables like the indicators proposed by the method also have a static value at the end of a period reflecting the period change, (the incremental value relative to the incremental value of previous period) thereby the calculated variables measure the time-differentiated change and similar to what is mentioned above when added to an initial value from an antecedent period, the calculated indicator values may be cumulated to indicate change over a longer time horizon (the global effect) thereby reflecting the cumulated or dynamically updated given effect on a given initial baseline value.

This is better shown by taking for example Y:

Y⁰ is the value of Y previous to Y¹. Y⁰ can be the value of Y in a period prior to any given tⁿ and then Y⁰ will be the value of Y measured at time tⁿ⁻¹. Y⁰ is therefore also the initial value of Y at the beginning of period t for any given time horizon spanning over a number of periods t, from t=1 to t→∞. And when looking at the flow of a variable within a given time period, Y⁰ is the initial value of Y ex ante, that is the value taken by Y for any period t at the start of the period. It is a base value and its positioning in time (and relative setting) depends on the context of the analysis. If the analysis performed by the method is a marginal analysis analysing the incremental trend from period to period, then the base value is the value of Y at the end of the previous period-either the immediate previous period or any past previous period compared to the current period being analysed by the user.

Setting the period t to an interval length of any given length, for example a month, this means that Y⁰ is the ex ante value of Y at the start of the first month of recording. In the first time period of any activity ever the base value of Y⁰ is then 0 or any other value defined by the operator or the user as corresponding to null activity or to a background level of initial Y. Then if the analysis is performed in a modus that adds the flows to the base value, the initial value of Y at any given period will be the flow variable resulting from the baseline value to which are added the flow achieved by the end of the period tⁿ⁻¹ for any given period tⁿ being studied. If the analysis is performed in the incremental modus, the effects studied are not added to the base variable of the start of recordings, but the base variable is shifting from period to period and is reset to 0 (or the background level or null-activity level initialised by reset) at the start of each period. Changes due to the activity performed leading to Y accrues during the period and at the end of the period, Y^{t} is recording the flow in all y(xᵢ^{t}) that took place from the start to the end of the time interval defining t. Then at the start of the next time period t+1, the initial value of Y^{t+1} ex ante can be set to either Y⁰ being set as the value of Y at the beginning of period t (and the analysis is in the flow analysis modus, looking at the flow since the start of period t) or again initialised to 0 (or other baseline value initialising by reset) and the analysis is in the incremental modus (looking only at the change accrued from period to period and not looking at the cumulated level achieved)

In the first case, Y is a flow variable for Y over time measured as the cumulated value in Y updated by the recorded value for each separate time interval. Y is the flow cumulated over several time periods:

Y^{t0}+Y^{t+1}+Y^{t+2}+ . . . +Y^{t+n}=the accumulated flow in Y since the initial record startin at period (or time) t⁰ and updated each new t for a duration of n periods until period tⁿ

and the same applies for Q (accumulating q(xᵢ)) and all other flow variables calculated on data input that is flow like:

However for incremental change, the accumulated flow of the increment recorded for each period is not added to an initial baseline value:

(Q^{t1}−Q^{t0}) being the increment in volumes during period t1 and that would accrue to the flow of Q from previous periods, when looking at the accumulated increment in volumes during n periods of time a formula to use would be:

(Q^{t1}−Q^{t0})+(Q^{t2}−Q^{t1})+(Q^{t3}−Q^{t2})+ . . . +(Q^{tn}−Q^{tn-1})

and when looking at the accumulated effect or flow in the time-differentiated or periodic increments in the indicator values for the three basic effects separated by the suggested method, a formula to use would be:

(1+ΔP^{t})*(1+ΔP^{t1})*(1+ΔP^{t2})* . . . (1+ΔP^{tn})=or a factor reflecting the accumulated effect of price changes and to be applied to a baseline value which could be:

using the baseline value at the baseline period (or time) set as

Baseline value at t^{*}=100

then the baseline value is indexed by the aggregated effect of cumulative price changes accumulated after n periods at time tⁿ since t^{*} is:

Index of price effect at tⁿ=100*(1+ΔP^{t*})*(1+ΔP^{t*+1})*(1+ΔP^{t*+2})* . . . (1+ΔP^{t*+n})

It is possible naturally to substitute to the baseline value set as 100 the actual value of the outcome being studied, and substituting the value of Y (the flow variable) achieved by period t^{*} representing any chosen period from which to study the impact of the separated effects on Y of ΔQ, ΔP and ΔX as proposed by this method and with the period t being selected at the initial period of the data set or any selected period subsequent to the initial value, the initial value represented by t⁰, then:

Baseline value at t^{*}=Y(t⁰)+ . . . +Y(t*)

And the impact of ΔP on Y at time tⁿ as compared to time t* is separated and distinct from the other effects by:

[Y(t⁰)+ . . . +Y(t*)]*(1+ΔP^{t*})*(1+ΔP^{t*+1})*(1+ΔP^{t*+2})* . . . (1+ΔP^{t*+n})

Likewise for the other indicators, where the increment in absolute terms the relative increment or relative difference, the cumulated difference over a span of several time periods, and the dynamic impact measured on a baseline chosen as mentioned above can be calculated for the other indicators for the volume effect Q and for the bundle-mix effect X.

Setting the Optimal Period Length

However just like the time horizon of the analysis can be defined as a number of time intervals each representing one period, the length of it is well-defined, so that each period start is equidistant and the whole time horizon represents a time length consisting of n periods, each period of time can be redefined and split into sub-intervals consisting of shorter time intervals. This can be done in principle as a sub-division of the main period in sub-intervals or by redefining the period length to a lesser time amount, thereby creating shorter (closer to each other) equidistant points in time.

But another way to subdivide the period-length is to let the interval length of the subdivisions be defined by any given change in prices(unit values), so that for any p(xᵢ) observed during the time interval tⁿ defined as [tⁿ⁻¹, tⁿ] for which a change is recordable and is recorded as a value p(xᵢ)^{t*} and where p(xᵢ)^{t*}≠p(xᵢ)^{tn-1} and tⁿ⁻¹<t*<t^{n,} then the time interval to be used by the method should ideally be subdivided into [tⁿ⁻¹, t*] and [t*, tⁿ] . Naturally the purpose of such subdivision of the period-length is to introduce time intervals separating periods where the value of p changed, since the occurrence of such a change introduces an element of discontinuity in the time series recording for the flow of q(x) for which the change in p occurred as well as it may impact on the other q(x) , and by introducing a dynamic period definition repetitive calculations may be avoided while discontinuity in the line of data recording is controlled, thereby securing the explanatory context for interpreting the findings of the analysis and comprehending these. Changes in the value of p could very well take place and impact on q, y and Y and the impact not properly assessed if the change went unrecorded as it might be if the values are not adjusted and redefined by setting period intervals. In they the period intervals are not set as a minimum when such a change occurs then the end point values of p are incorrect and the q attributed to each item i is related to a wrong p(xᵢ) value.

When the sub-divisions of the period length are defined in such a dynamic way, there is no a priori of periods rigidly defined by equidistant points in time and in parallel to measurements in time recorded by the number of periods elapsed, a recording of the length of each sub-interval in a given appropriate time unit is needed to relate the impact of any effect to the length of the dynamically defined sub-interval and to be able to add up the sub-intervals.

However, the dynamical adaptation of the recording is not always feasible for practical reasons. To be able to perform the dynamical adaptation of time-intervals, the system must receive periodic updating within the time period so that change is recorded immediately upon taking place or is known ahead. Not all decision-makers can control their data input. Some are price-givers (they impact on the value of p) and others are price-takers (they must adapt to the value of p given to them in the context of the activity, transformation or transaction). The dynamical adaptation of data proposes an option for those users that can make optimal use of the option, but the method offers alternative ways to optimise the results of calculations on sub-optimal or poor data quality, for example by redefining the period length to equidistant points in time closer to each other (shorter time period length) or further away from each other (longer period length)) and by combining period lengths of different time length after having viewed the data and analysed the updating frequency and recording frequency of data.

In practice the situation with the dynamic option for setting the period length is best used by decision-makers that control the setting of the value of p or the information controlling pricing or controlling the definition in the value p(x). This is most likely to happen when pricing (defining the transformation value or transaction value for any x) is an internal decision to the organisation with no externalities. When the method is used for cost analysis, the decision-makers in for example a production environment that have knowledge of exact factor input prices and amounts needed for production ahead of the production/activity actually taking place are also better in control of their data. For those users where the pricing/value setting of p(x) takes place during the activity or the exact amount of factor input is only known after the activity took place, the situation is similar to decision-makers whose role on the market is of price-takers, and this includes also consumers and economic entities involved in retail with limited manoeuvring space around sales price setting. Much of this control is defined by the institutional set up of the market and the legislation applicable to that market/branch/industry.

Some markets are regulated by directives or legislation aiming precisely at setting up an institutional frame for the pricing of products and for the frequency with which products can enter or exit the market, this being a strategic tool for competitive positioning and for marketing. However some markets—defined both as product markets or geographical markets—are not subject to any such legislation.

Similarly in a context that is not related to a market per se, like in the example of pollution monitoring, the recorded variable reflecting the evolution being monitored (the CO gasses and their concentration in the air) is the result of values in p(x) (in this example the p(x) value is the amount of CO produced per kilometre driven or per litre fuel burned in reality that is as it takes place in the traffic jam, whereas the evolution monitored is compared to what might be ideal circumstances if the same vehicle park passing by a given time and place polluted the air according to the ideal emission rates defined per model of vehicle by the manufacturer. In this context the authorities or organisations measure the total effect resulting from numerous vehicles and may derive by using this method how much of the increase in the level of CO stems from more traffic volume and how much stems from the types of vehicles passing by or from the discrepancy between their ideal emission rate and their actual emission rate. The authorities monitoring the air are “price-takers” in that they cannot while they are observing the pollution act on the level of the p(x) at stake, although they may at a later stage try to impact on it by different regulations and policies.

Also product entry and product exit (or introducing and abolishing services) is an issue to consider and relevant for setting the optimal period length. Just as any given change in p(xᵢ) should ideally command a subdivision of the time period so should any product entry or product exit (the product being either added or taken off the official supply options).

The ideal situation being that such product range adaptation should command a new subdivision of the time period, a way to countervene this, when it is not possible to design the record data base dynamically, is to set the period length to very short time intervals during which the probability for any change going unrecorded and affecting the market situation is as low as possible.

By subdividing the period length and reducing the interval length better data is obtained. By subdividing the period length and defining the interval end points according to dynamic change even more accurate data is achieved and redundancy in calculations is avoided.

However short period length or dynamically adapted sub-intervals (the points in time are not equidistant) are ideal situations that are not always achievable and the cost of data quality improvement by improving the gathering, recording and should be—and is—often taken into consideration. High data quality should be understood in the sense that the quality necessary to secure updated time series variables without discontinuity or rupture is provided and where possible discontinuity due to changes in the variable contents is occurring, explicit definitions of changed variable contents should be recorded and implemented in the database.

There is a trade-off effect between on one hand better quality of data and improved accuracy of analysis and on the other hand necessary cost of obtaining the data and more detailed (but also more complex) analysis.

The realistic expectations to the data entered into analysis implemented by the method is therefore that the ideal situation is only one, rare outcome out of many possible outcome providing the analysis with sub-optimal data sets. The data made available for analysis night even be of a poor quality.

It is therefore to be regarded as one of the strong aspects of the method that the information package yielded by the set of three indicators is informative enough to provide insight into the characteristics of the economic system or technical system being analysed—even in the situation where the data available is of poor quality. The indicators do not fail to provide an insight that cannot be achieved by purely looking at absolute or percentage changes in flow variables. Also and maybe more important the indicators help redress the problems inherent to calculating price indices and linked to what happens to the accuracy and the relevance of the price index and its value, when the composition of the basket of goods entering into the price index not anymore is reflecting the flow of goods available and traded or resources transformed or utilisation. The method addresses exactly this type of problems otherwise not solvable because the missing part is how to adjust the composition of the basket and in doing so and adjusting information is lost as to the impact on the performance output Y of shifting basket compositions. Thereby addressing the problem uniquely by changing the composition of the basked limits the operator or the decision-maker with regards to the validity of the price index when the composition is not monitored and changed in time. It also introduces another problem which is whenever the composition of the basked is changed the time series is interrupted, since the basket has changed and is not comparable. Therefore at best addressing the problem only by changing the composition of the basket is disrupting the analysis of how the performance evolves over time by subdividing a time horizon in discrete time intervals within which performance assessment is not chained to the previous periods and prevents from projecting expectations into the future if the future basked is expected to be different without a priori knowledge of in what way it will be different. The method addresses the problem of changes in the composition of the basket and of price index calculation problems and the method therefore is highly recommended in cases where change occurs fast and often or where change is not predictable.

Therefore the method is applicable to ends that not merely are to define strategies, to simulate future evolution or to monitor a course, the method is also applicable to go through a database full of records and assess the quality of the data also in the event of using this data for performing another type of analysis different from the method presented here. In this case the method presented here can be used simply to prepare the data for analysis by defining pockets of data that are of poor quality and isolating these, the method being able to perform calculations across as well as within the data structure already in use in an organisation/company and therefore systematic record failures affecting data across groups or coincidental data failure within groups can be found. This application field of the method is also called data reengineering as the database is redesigned or cleansed of disruptive data pockets and the analysis is performed on cleansed or sometimes restricted datasets, thus limiting somehow the scope but providing findings that are more truthful.

To define the formulas used by the three indicators of the method, the variables are calculated for two time periods, t1 for the current time period and t0 for the previous time period and it is one essential aspect of the method to—prior to any calculations—check the data and analyse the options for defining period length. The optimal period length is suggested in relation to the scope of the analysis asked for by the user, and then the available database is analysed to check the frequency of updating and to see whether yes or no the optimal period length is feasible. If no, an alternative period length is suggested (the shortest feasible) and the user is in the same time suggested to consider the possibility to feed the system with already available better data (updating is available but was not performed) or consider the option of acquiring better data.

If this is not relevant here and now, the analysis performed uses the default, which is the shortest feasible period length taking into consideration that the minimum data set should contain information on transaction prices and transaction value for a period with no (unrecorded) change in unit volume and no (unrecorded) change in listed price. Additional information as to volume is beneficial but with unchanged unit volumes, the volume per transaction can be derived. Or if volume units are changing during the period (for example by the entry of new products that are the same in substance but different in packaging or concentration), then either volume information or product entry information preferably is part of the minimum data set and period length reset accordingly with the appropriate sub-intervals.

The system then sets the period length in such a way that the frequency of recorded data on changes in prices and changes in the range of products/output should match the frequency of recorded data on output values and output volumes. Thereby the system is minimising the risk for an introduction during the period of a change, the timing of which then would be unaccounted for, rendering it not possible to define a time period as an interval of time within which the prices are constant and no product entry nor product exit takes place.

The analysis can be performed on incremental values or on flow variables. However in order to clearly explain the method and in order to limit the number of variables and notations and signs in the formulas, the formulas are here defined for incremental values. With the needed adaptation the same method is applicable to flow value.

In the following whenever a variable z^{t0} is introduced and a variable z^{t1} compared to z^{t0,} then z^{t1} measures the value taken by z for the period t1 and the variable z^{t0} measures the value taken by z for the period immediately prior to t1, namely period t0, thereby comparing the performance in z during one period subsequent to another period of similar length. For clarity it is assumed that t0 is the period immediately prior to t1 and that t1 is the current period. However the method is also applicable to any given tⁿ and t^{*} and the application of the formulas can also be made on time periods not subsequently following each other whenever this is logical to the user, for instance for comparing different periods where a similar event takes place or where the event takes place in one period and not at all in the other period (testing the 0 hypothesis). In any case the method calculates by default the time series (the unbroken flow of values accumulated by the evolution taking place during each period in the time span recorded) of variables, the changes in variables and indicator values in order to sum up over time the cumulated impact on the effects of the change being studied.

And just as the unbroken record is preferred so is the opportunity to compare time periods of similar length but not subsequently following each other, it is relevant to study disparate periods when the effect of some phenomena occurs repetitively with a timing and duration separated by time periods with no such phenomena.

An example of such a phenomena are seasonal patterns and their influence on performance for any activity, transaction, transformation or utilisation subject to seasonal cyclic patterns. A seasonal pattern can be expected for example for sales in the fourth quarter of the year or more precisely during the month of December when it comes to the sales of items much in use or not at all in use during this time of the year, or typically for the season with the sales boosting effect of the Christmas and New Year holidays. A decision-maker would then want to compare the performance related to the Christmas sales and end-of-the-year sales of a particular year with that of another year.

Another example is the scheduled timing of an event that is not per se a seasonal fluctuation and maybe even occurs at different calendar periods. For example a decision-maker wanting to analyse the effects of sales during festivities under the lunar calendars used in Middle-Eastern countries would want to compare specific periods (like the month of the Islamic festival of Ramadan or like the month of the Jewish festivals at the beginning of a new year Rosh Hashana) but these festivals fall each year on different (Roman calendar) dates and do not follow the month/year periods of the Julian calendar. Islam and the Jewish religion use lunar calendars. Due to the differences in the lunar year and the solar year, the timing of such events defined by the lunar year fall on different periods of the solar year. Decision-makers in these regions normally act and plan according to a fiscal year defined as the (Roman) calendar year and would want to compare periods defined as the festivity periods occurring during different Roman calendar months each year.

Another example, this time of stochastic timing of events, might be of decision-maker wanting to study the pharmaceutical drug sales patterns during an influenza epidemic occurring in November in a given year and having taken place in March during another given year.

Another important reason for describing the formulas in this method in general terms as two measurements in any of the variables, that is formally writing any variable z relevant for the method as z^{t0} and z^{t,} is that the same formulas are applicable to comparisons within the same time period or time horizon for geographically different units.

By designating one unit as unit 0 and the other unit as unit 1 the same analysis regardless of whether it is conducted as an intertemporal analysis or as comparative analysis across two different locations and within the same time period can be applied and reveal differences in volumes transacted/transformed or utilised, in the price differential in the pricing of identical product ranges( in the transformation value per unit of identical resources), and in the mix effect on the value of the result Y so as to reveal the same type of insight related to the trend and the extent of the effect of these three indicators on the outcome Y.

From this it can now be understood that Y is a formal denotation for any given outcome on which it is expected that the volume, the prices (value per unit) and the mix of the bundle of items leading to total Y has an effect, as long as Y is quantifiable and as long as a relation can be established between Y and any given xₙ recorded in the product or service or resource range vector rₙ=(x₁, x₂, x₃ . . . , xₙ₋ₙ, xₙ), and for y(x), q(x) and p(x).

Definition of Formulas and Calculated Variables for the Indicator Variables:

Y at time t or Y(t) is defined as: Yₜ=Σy (xᵢ)^{t}, the turnover/transacted/transformed/utilised or consumed value of any group or grand total and composed of one or more than one y (xᵢ) for t (or located in a place t). Y is further defined for the xᵢ comprised in the vector rₙ mentioned above.

Y in the antecedent period or Y(t−1) is defined as: Yₜ₋₁=Σy (xᵢ)^{t-1} the turnover/transacted/transformed/utilised or consumed value of any given total of y(xᵢ) for t−1 (or located in a place t−1)

ΔY for t is defined as ΔY^{t}=(Y^{t}−Y^{t-1})/Y^{t} the relative increment in the performance value during period t as compared to the antecedent period t−1 (or between location 1 and location 0 as compared to location 0)

To define the incremental effect of price changes, a first step is to calculate the increment in absolute terms at the basic or unit level of each item xᵢ. This increment at item level is Increment in p(xᵢ) during t=p(xᵢ)^{t}−p(xᵢ)^{t-1}

Likewise for any other q(x) or y(x) thus defining the increment at item level

The increment at item level is used to calculate the aggregated impact at group or bundle or at grand total level: the impact on Y of changes in the prices or in the item values is measured by the incremental price effect, ΔP, and/or by the impact of ΔP on a baseline value of Y where ΔP is showing the change brought to Y by all the changes in p(x) for all items included in Y since the previous period or since period start and the impact of ΔP, or its effect on Y, is showing its impact on a baseline value for Y and ΔP can be calculated in several ways, two of these are mentioned hereunder as method p (p for ex post ) and method a (a for ex ante), and in the following example the method p is used. Method p is also equivalent to the method known in micro-economic literature as Paasche's index formula and method a is also equivalent to the method know as Laspeyres's index formula.

These represent the two endpoint angles and other methods exist mainly transformations of these two endpoint angles.

Method p:

ΔPₚ=Σ[wₚᵢ*((pᵢ^{t}−pᵢ^{t-1})/pᵢ^{t})]

Where the new variables:

ΔP is the incremental price effect or increment in the price index value for any Y defined as a group of n elements of items xᵢ and ΔP measures the effect of price changes on Y from one period to another, (from the previous period to the current period in the calculation of the flow variable for the price index measuring the continuous and accumulated effect of price changes/unit value changes over time)

and

pᵢ^{t} is the item price/unit value of xᵢ (the product i taken from the product range vector r^{t1}) at time t and pᵢ^{t} is in effect during the time period indicated by t,

and

pᵢ^{t-1} is the previous item price of xᵢ (the product i taken from the product range vector r^{t-1}) and pᵢ^{t-1} was in effect during the time period indicated by t⁻¹, provided that the product range vectors r^{t} and r^{t-1} also contain the same x_{i,}

and

wₚ is a volume weight based on the ex post values of volume transacted during the period, in practice and when comparing two subsequent periods t and t1 this will be done by taking the volumes transacted during period t1 for calculations performed on Y of period t1 and defined as wpᵢ^{t1}=qᵢ^{t1}/Σqᵢ^{t1} for all i=1, . . . n and similarly by taking the volumes transacted during period t and defined as

wpᵢ^{t}=qᵢ^{t}/Σqᵢ^{t} for all i=1, . . . n or when comparing two periods that are not subsequent the ex post value of each period is used to describe that period, or in the case of a chain of time periods, a chronological sequence or time series the ex post value of each period is used and a chain index is generated linking the resulting ΔP into an index flow of incremental change.

From this follows that if xᵢ is not contained in the product range vector for t−1 there will normally not be any pᵢ^{t-1} or if there is such a pᵢ^{t-1} but xᵢ is not available in reality then there will be no q(xᵢ) or it will be null. Therefore the price effect on Y of introducing xᵢ cannot be calculated when the ex ante value initialisation for pᵢ^{t} cannot be taken from the ex post value of the previous period or if it can but there were no q(xᵢ) because during t−¹ the product or resource was not available, then again the impact on Y during the subsequent period might be calculated but is not accurate when comparing to Y of the antecedent period, since x did not exist other than on a listing. When the item in question was not recorded in the product vector of the previous period and no price was listed, then the value ex ante of pᵢ^{t} is a missing value. However if the value initialisation of pᵢ^{t} is the entry price defined and recorded specifically for the period t ex ante or at the start of the period, there will be two end points for the period of t and the interpretation of results will be assisted by listing entry price levels and new product entries.

The Method Therefore Also Includes Considering an Appropriate Value Initialisation for the Calculations Performed.

Also if xᵢ enters the market/the survey of activity and performance later than the start point of t, it will not be recorded in the initial product vector r of t. However in both cases xᵢ exists and has an effect on the performance or the activity, yet is usually not listed since it entered with or without registration but after the initial product list was established. The distortion created by these technical problems is expected to have some effect—sometimes much effect—on the accuracy of the calculations, the extent of which depends on the data set. Such distortion is not always a matter of coincidence but can result from strategic considerations from marketing teams wanting to avoid impacting on the general market performance to hide their entry and its true impact from competitors or sometimes to escape the eye of the regulator watching the price index of markets providing services and products being regulated. This practice has for example been recorded by the inventor in the context of analysing the market of pharmaceuticals in Denmark in the context of policy recommendations and analysis performed to measure the effect of diverse regulatory measures on the pricing and therefore on the cost level of pharmaceuticals that receive public subsidy. The price index was used as an indicator for the cooperative behaviour of the pharmaceutical industry in accepting a self-imposed limitation on price escalation above normal inflationary pressure in order to avoid more restrictive regulations passed by law. However introducing product right after the composition of the price index was established was a strategic way to avoid a collective punishment in the form of regulatory measures and yet get away with pricing in excess of the informal agreement between the industry and the government.

However here this inaccuracy is accounted for later in the method and its total effect on Y together with the other sources of inaccuracies is much reduced as compared to the conventional analysis that does not separate the effects of the three indicators clearly, or does not involve the bundle-mix as a dimension in itself.

Calculating the Cumulated Price Index

Now that ΔP is calculated for the period t, the cumulated effect on Y of price changes due to the flow of goods and services and price changes or changes in item value since the previous period can be calculated and the impact on Y compared to and added to the initial value.

Setting the initial value of Y at the time t to a basis index value of 100, the formula for calculating the cumulated price effects over time from t−1 to t or from any point in time t to a time t+n periods is after n periods of time for any n, tⁿ and for any t:

Setting the initial value of Y at the time t to a basis index value of 100, the formula for calculating the cumulated price effects over time from t−1 to t or from any point in time t to a time t+n periods is after n periods of time for any n, tⁿ and for any t:

Cumulated Price Increment=(1+ΔP^{t}))*((1+ΔP^{t+1})* . . . *(1+ΔP^{tn-1})*(1+ΔP^{tn})

And Baseline value at time t0=100

which gives the

Cumulated Price Index=100*(1+ΔP^{t}))*((1+ΔP^{t+1})* . . . *(1+ΔP^{tn-n})*(1+ΔP^{tn})

so that if Y^{t}=100 then the Cumulated Price Effect on Y shown by the Price Index value at time tⁿ will show the value of Y at period tn as it is when only the effects of price changes after being separated from other effects are impacted on Y from time t throughout the n periods until reaching time tn. And by substracting 100 to the value of this Cumulated Price Index value, the total relative difference from y at time t to Y at time tn is found.

Other Usage of the Price Formula by the Method:

The price effect formula can also be applied in another way. Instead of measuring the difference between two time periods t and tⁿ (either by way of the immediate incremental value from the initial period to the subsequent period or by way of the accumulated increment) the formula can be applied to analyse differences in pricing or in costs between two independent units. Using the same variables as defined here, the only meaningful, situation is such situation when the product range vector r is almost identical between unit 1 and unit 2, because any xᵢ contained in one vector and not in the other will result in missing values. This situation is identical to the requirements to the product range vector over time when comparing two time periods. These situations occur between locations where the same or an almost identical product vector is available but at different costs, prices or with different unit values, for instance when measuring CO gasses with the same type of vehicles circulating in general but with another rate of transformation in transforming fuel into (transport) and pollution because By establishing the product/resource/service range vector for each period and checking for product/resource/service entry and exit the two profiles can be matched. A comparative analysis of listed products matching the two r vectors will point to discrepancies and by taking out those products that were listed in the past and now exited, a partial bundle-mix analysis can be performed, to derive the relative impact of the exiting products from the past period and relate this to Y to have a measure for the relative importance of the exiting products. In practice though in a market set-up, exiting products will rarely have a relative importance, since the exit often is motivated by falling market performance. Abolished services or missing resources might have another kind of impact on Y in the context of services provided or in the context of the production or transformation of resources, like say, the interdiction for buses with no catalytic filter to enter narrow streets in inner town areas on days with climatic inversion would certainly have an important impact on the level of CO measured in those focal areas on these particular days.

The relative share of exiting products/services/resources is also of informative value as it may be part of a strategic adaptation by product renewal. An exiting product with a seemingly sizeable share of Y is therefore something to watch. The system should then record this exiting product and its characteristic and be on the look out for new products entering the markets with the same basic features (allowing for added or slightly changed features) with another pricing level taking into consideration another packaging size and another concentration (when relevant). This is performed by the system by matching a three step analysis that also can be used for temporal differences in the product range vector for the same unit and consisting of:

Step I. Analysing rₙ^{t}=(x₁, x₂, x₃ . . . , xₙ₋₁, xₙ) to survey changes at each set of periods t by matching the identification data on the variable xₙ in between the different t periods

Step II. Listing all discrepancies defined either as a product entry (a new product) or a product exit (a product leaving the resource vector) or as a change in the product characteristics in any given x being part of the resource/product vector of previous periods and listing the relative share of x to the Y for each period.

Step III. Storing a list of discrepancies and the relative shares of x in Y as found in step II into the system and systematically by default checking the product vector at each subsequent period t for the re-entry of a similar product and enabling the user to turn on this feature and receive a warning of previously exited products now re-entering the market in a similar or changed version. The value of p(x) being stored also for calculation purposes, the change in p(x) will be provided as well if relevant. The product/resource version is analysed using the basic features characterising products/resources/services defined by the listing in II, and allowing for product differentiation by specifying for each identification parameter (substance, colour, concentration, volume units, number per package, presentation, additional related features like PR-related for example promotion goods and the like) a value for the allowed or uninteresting variation on the parameter—either numerical or a dummy variable—and checking for changes in the parameter value to report changes in the scope of interest.

If the two vectors are more or less identical in product range (not only by the number of items but also by their characteristics and contents for all xᵢ belonging to one location and the same xᵢ paired to the one from the first location and belonging to the other location) and the sensitivity required to check the product range vectors can be defined either being set by default by the system (or can be set by the user, using the user's intuitive knowledge of how much difference the analysis can tolerate in the views of the user) then the price effect formula ΔP is applied to the two units and one unit, unit 1 (or 0) is chosen as the “reference” unit or the base unit. Any value for ΔP (and for any of the other variables, the input variables, the calculated variables and the calculated indicator values) will then reflect the difference—not in time—but between the behaviour/performance of unit 2 (or 1) as compared to unit 1(or 0). The substitution is made by substituting the values of variables of unit 1 or the value of time period t−1 (the reference or base unit replaces the base period) and by substituting the value of variables of unit 2 for the values of time period t (the unit to compare to the reference or base unit replaces the values of the subsequent time period t).

The Price Index Can Also be Calculated According to Method a:

ΔPₐ=Σ[wₐ*((pᵢ^{t}−pᵢ^{t-1})/pᵢ^{t-1})]

Where waᵢ is a volume weight based on the ex ante volume transacted, in practice in the example above by and when comparing the subsequent periods t and period t−1 by calculating was based on the volumes transacted during period t⁻¹ as waᵢ^{t-1}=qᵢ^{t-1}/Σqᵢ^{t-1} for all products i=1, . . . n, and as can be seen the ex ante volume weight entered to calculate the effect of prices on Y during the period t considered is in effect the volume weight defined by the composition of Y of the antecedent period (here t−1) and should there be any seasonal or other fluctuation in the volume of the antecedent period this will impact on the calculation of the subsequent period. Therefore the method also includes transformations of w like an average for each wᵢ calculated over a number of periods.

Determining the Volume Effect:

To determine the volume change, ΔQ^{t}, can be effectuated in different ways, in the example it is calculated as:

ΔQ^{t}=(Q^{t}−Q^{t-1})/(Q^{t-1})

where the new variables are calculated as:

Q^{t-1} is calculated as

$${\sum }_{i = 1}^{n} {q}_{i}^{t - 1}$$

Q^{t} is calculated as

$${\sum }_{i = 1}^{n} {q}_{i}^{t}$$

Determining the Bundle-Mix Effect Index and Increments in Its Value ΔX

To define the effect of changing compositions of Y on Y another dimension is introduced and proposed in this method to complement the calculations entailed among others by the price index formulas and this new dimension related to the composition of Y is called the bundle-mix index and increments in its value, ΔX proposed by the inventor as a dimension of its own, can be calculated in several ways, two of these are described hereunder and will be called here method p and method a to match the ex ante and ex post terminology used for the price index formulas, and in the following example the method p is used.

Method p:

ΔXₚ=100*[(Σ(wpᵢ*Q^{t-1}*pᵢ^{t-1})−Y^{t-1})/Y^{t}]

where the variables are defined as in the above mentioned formulas.

Method a:

ΔXₐ=100*[(Σ(waᵢ*Q^{t}*pᵢ^{t})−Y^{t})/Y^{t}]

and where wa and wp are calculated as mentioned previously

An example of calculations of the price effect shown by the price index and the other indexes here under is intended to demonstrate that the bundle-mix index ΔX is needed to explain any unexplained difference between the increment in Y and the combined effects of changes in prices and volumes reflected by the increment in the price index added to the increment in volumes:

| Item label | p⁰ | p¹ | q⁰ | q¹ | y⁰ | y¹ | w^{D} |
|---|---|---|---|---|---|---|---|
| 1 | 10 | 10 | 20 | 15 | 200 | 150 | 0,333333 |
| 2 | 30 | 30 | 5 | 10 | 150 | 300 | 0,222222 |
| 3 | 20 | 20 | 10 | 15 | 200 | 300 | 0,333333 |
| 4 | 15 | 15 | 10 | 5 | 150 | 75 | 0,111111 |
| total | | | 45 | 45 | 700 | 825 | 1,000000 |

From period t0 to t1:
Delta Y 17,86%
Delta X 17,86%
Delta P 0,00%
Delta Q 0,00%
Rest 0,00%

In the example above, there is no change neither in prices nor in the total volume Q transacted during the period while the output or performance Y increases, Y being the total performance value (like for example total sales value in monetary terms) of products/services at any group or total level desired.

Although the prices are constant and have not changed during the time surveyed, period t0 and period t1 the less the value transacted (here in this example it could be the sales value) has never the less changed, increasing from 700 to 825. A difference or change in sales (or any other context and performance expressed by Y) similar to what is described in the above mentioned example can now be explained by way of introducing the value of the bundle-mix index ΔX (here in the context of sales it is the sales pattern or product mix picked up by consumers) as an explanatory variable. The value of ΔX is 17.85% reflecting that only by a changed product mix, (changes in the relative composition of Y, not in its total volume) the effect on Y created hereby amounts to an increase of 17.85% all other dimensions being 0 and the change in X therefore impacts fully on the value of sales performances. The performance Y increased 17.85% and the conclusion in this case is that the bundle-mix (the sales pattern) is the sole reason to all changes in performance value. Naturally only few examples in reality consist of a few products/services and can be reviewed instantly, therefore the method is a way to achieve immediate insight over complex situations with many products/services or resources or time periods to consider. One can easily imagine how is the situation of a controller in a HMO or of an administrator at national level in a health sector having to review the thousands of departments or wards of the hundreds of hospitals across the country to determine the reasons for deviations from expected performance (budgeted total costs) and whether and how much the deviation stems from increased pressure and usage, gliding costs or unexpected composition in the mix of services delivered or in the profile of users within given services (for example more heavy cases within given diagnose types) which is what the method could be used for to review instantly and deliver indicators for cross-comparison, also for cross-comparison of performance of services or merchandise accounted for in units that do not allow direct comparison.

In the next example there is a change in volumes as well as a change in the bundle-mix;

| Item | p⁰ | p¹ | q⁰ | q¹ | y⁰ | y⁰ | w⁰ |
|---|---|---|---|---|---|---|---|
| 1 | 10 | 10 | 20 | 25 | 200 | 250 | 0,431034 |
| 2 | 30 | 30 | 5 | 10 | 150 | 300 | 1,172414 |
| 3 | 20 | 20 | 10 | 13 | 200 | 260 | 0,224138 |
| 4 | 15 | 15 | 10 | 10 | 150 | 150 | 0,172414 |
| total | | | 45 | 58 | 700 | 960 | 1,000000 |

From period t0 to period t1
Delta Y 37,14%
Delta X 6,40%
Delta P 0,00%
Delta Q 28,89%
Rest 1,85%

The impact on Y due to changes in the volume flow ΔQ is quantified as an increase of 28.89% and the impact on Y due to a change in the bundle-mix is quantified to be of only 6.40%, less than in the previous example. In this example the 37.14% increase in sales (in the value of Y) is mainly due to a volume increase in sales while only 1.85% of the change in Y goes unaccounted for as the residual value contained in “Rest” amounting to 1.85%.

In the last example the volume flow, the product mix and the prices have all changed in the same time:

| Item | p⁰ | p¹ | q⁰ | q¹ | y⁰ | y⁰ | w⁰ |
|---|---|---|---|---|---|---|---|
| 1 | 10 | 12 | 20 | 22 | 200 | 264 | 0,407407 |
| 2 | 30 | 28 | 5 | 10 | 150 | 280 | 0,185185 |
| 3 | 20 | 22 | 10 | 10 | 200 | 220 | 0,185185 |
| 4 | 15 | 22 | 10 | 12 | 150 | 264 | 0,222222 |
| total | | | 45 | 54 | 700 | 1028 | 1,000000 |

From pericd t0 to period t1
Delta Y 46,86%
Delta X 7,14%
Delta P 19,14%
Delta Q 20,00%
Rest 0.58%

sales (or the increase in Y) here increased markedly by 46.86% ,and as is shown instantly by the indicator values of ΔP, ΔQ and ΔX the causes are price increases amounting to 19.14% ( as the price change index shows a value of 19.14% ) and a volume increase of 20.00% with ΔQ reaching 20% and a bundle-mix effect on Y of 7.14% due solely to changes in the sales pattern as the bundle-mix indicator amounts to 7.14%. Seemingly and although prices are increasing, consumers are not refraining from buying more and from buying different goods with more of the expensive products purchased thereby also contributing to raise the level of sales.

The bundle-mix or product mix effect (sales pattern effect) in this example has a positive impact, reflecting that consumption patterns by way of product substitution induce the selection of a higher priced good/service (to be clearly distinguished from the impact of purchasing goods the price of which has increased, these two effects being clearly separated by the method!) so sales from some more expensive items increased over sales of less expensive items as compared to the previous period, pushing up the value of total sales. In this example the Item no. 2 represents an expensive item that doubled its traded volume, thereby bringing its weight of the total turnover from 11% to 18.5% (or a relative increase of its weighted share of Y of 70% thus a significantly higher increase than should be expected by the general volume effect of 20% shown in this example). Volume increase in items 1 and—to a certain extent—in item 4 (an incremental value of 10-20%) do push sales by way of the volume increase but will not impact profoundly on ΔX as does the doubling of sales of the high product-range item nr.2, being in spite of a slight price cut still the most expensive item. Obviously the slight price cut in item 2 and the price increases in the low-range items contributed to more sales of item 2 (probably attributable to a narrower price differential) and thereby impacting on sales performance positively at the level of all 3 indicators, volume effects, price effects and sales pattern effect (or product selection effect). The rest value of 0,58% of the change in Y that is “left over” once all of the three effects are taken into consideration is due to normal inaccuracies to be expected from the calculation. These normal inaccuracies stem from the fact that the difference in Y is recorded, it is an observed measurement for Y at one period and an observed measurement for Y at another period and the same goes for the difference in volume and its impact on Y. However both the impact of prices and the impact of the bundle-mix are per definition effects that cannot be observed at an aggregated level. They are obtained only by calculation as the measurements that are observed are observable only at disaggregated (the lowest possible level) and are recorded as changes in the price (value per unit) of the most basic data level (the product or item unit) and as changes in the volume traded of an item and the relative share of this volume to the total Y. Since both the effect of price changes and the effect of the bundle-mix (or of the composition of Y) only may be calculated and cannot be observed there will in most cases be a discrepancy between the size of ΔY (observed) and the total achieved by adding up each of the components of Y broken down by the method into the separate dimensions of ΔQ (observed), ΔP (calculated) and ΔX (calculated).

Another cause for the residual value is in large datasets almost unavoidable and is due to technical data problems caused by missing values (data failure due to unrecorded or lost data, typically a lost price value) or missing end-point values as described previously in relation to setting the optimal time period.

A third cause for the residual value is due to the changes taking place in such a way that they do impact on total performance but are not recorded or take place surreptitiously so as to remain untraceable, typically as mentioned before when trying to elude competitors and launching a new product quietly right after the product listings (the product range vector) for the period was reset. The total performance of own and competing products will most certainly be affected but since the data (in this case the item name and characteristic entered in the product vector and the price) remain hidden, the total volume and the bundle-mix will most certainly be affected, the price index should be but will not and the total of the separate dimensions ΔP, ΔQ and ΔX will certainly be different from ΔY thereby creating a residual that could be positive or negative depending on the extent and the direction in which the indicators should have been affected by the unrecorded data.

By turning the residual into a variable of its own, it is possible to monitor the extent of such discrepancy, which is linked to the difficulties of obtaining full coverage by the data collected. The residual variable will then reflect the extent to which the data is affected, thereby offering an opportunity to the user to define a threshold limit above which the analysis is considered less meaningful or even is discarded—The residual variable will have another role namely that of indicating the existence of such missing values (this can easily be accounted for) and the database can then be reengineered accordingly or the missing values could be gathered otherwise. A third and important role played by the residual variable is to indicate to the user the existence of such elusive behaviour when the effect of missing values and missing end points can be eliminated as a major cause. Typically a discrepancy in the price index and unaccounted volume changes will immediately signal the presence of phenomena of the kind that impact on the performance of Y and are not traceable in the data. In this third application of the residual variable the method provides market or context specific intelligence that simply is outside the scope of the data and therefore has a value in its own.

It should be noted that in practice calculations of the price index figures published officially are much less refined than the tools offered by the present method and that such price index calculations are performed even with missing values, missing endpoints and with infrequent revisions of the composition of the index. Yet the official price index figures are very appreciated and used and play an important role for the calculation and the decision-making of hundreds of daily life activities, like mortgage calculations, wage claims, refund, projections of all kinds of budgets in all kinds of domains of activity and so forth.

Therefore the tools provided by the method can be trusted to deliver business critical information in spite of the problems of missing values and the like as their total impact on the indicators and o determining trends will normally always be less than the uncertainty linked to not so much the trends analysis and future predictions but rather linked to the choice of strategy and actions based on ascertaining the current trends and predicting future trends. The method will perform well as a tool providing business and decision-critical information and for revising the value of the price effect as well as for introducing a separate third effect the effect of the bundle-mix, all three allowing for an interpretation of data that extracts hidden trends to the point in some cases of delivering business intelligence otherwise remaining secret knowledge, because as explained previously elusive behaviour or unrecorded events leave a trace that is picked up by the method at the level of the impact it had even in the event that the organisation did not collect data pertaining to this event or this behaviour.

In the following a preferred manner of visualising output from n-dimensional analysis is described with reference to FIG. 1

A method for showing the output from analysing a multifactorial causal relationship. The n-dimensions represent the basic dimensions of time and place, defining the time and geographical localisation of the outcome, and represent also a number n of causes for a development in a given outcome, the outcome variable.

The output to be visualised consists of an outcome (performance) variable, and of two different measurements of the outcome, either two different places or two different periods being compared, a set of three basic trend indicators, indicating the extent of the three types of effect separated in the method (ΔP, ΔQ, ΔX) and representing each the effect of causal variable belonging to one of these three separate categories by way of how they impact on performance, and a set of additional explanatory variables (causal variables, the existence of which are expected or can be shown to affect the outcome or performance variable or to be correlated to it) to be chosen from a list of variables existing in the data set either by way of data collection or by way of calculating them based on the data collected and submitted for analysis and to be chosen upon request by the operator.

The visualisation takes place by way of:

In the centre of a screen or any other graphic output, the outcome (performance) variable is shown as a 3D-bar or any other 3D-representation presenting with well-delimited surfaces. The 3D-representation as a bar allows showing the first and the second measurement of the outcome as a continuation of each other, so that the highest value of outcome is the longest bar and the lowest value is a part of the longest bar. The length of the bars is proportional to the values of outcome (performance) to be represented graphically. Alternatively the two bars representing each their measurement of Y may be visualised as a pair one under the or one by the side of the other one

On one side of the central bar diagram a column of indicators show the relative difference between the two measurements in numerical form as a percentage value in a grid form and/or as a coloured indicator, the colour being defined to reflect a value interval on a scale and with a colour scheme to be chosen by the user. The default could be red for positive values and blue for negative values, (following the readings of a thermometer) and the indicator range would be from the maximum to the minimum recorded with for example three value intervals, values higher than 0, values equal to 0, values below 0, and three colours, red, white, blue. But a more graduated and more differentiated scale consisting of for example two positive, one zero or around 0 range, and two negative intervals is also possible and so is the use of more intervals, depending on the colour scheme and graduation of colours achievable. The sensitivity of the 0 range interval for example defining it as −0.5 to +0.5% or as −1.0 to +1.0% or whatever value is best fitted the needs of the user would preferably be set by the user to tailor the graphic output to the needs of the user. Similarly the scaling of intervals and the number of intervals would preferably be set by the user offering a choice for setting these intervals and their corresponding colours.

On the other side of the bar diagram, in this example to the left, the same graphical mechanism is used to represent the indicator values of a basic set of three indicators as proposed by the method for calculating the effect of volume changes, price changes and bundle-mix changes. This allows the operator to fast review and thumb through the profile of causes for change in any given outcome shown by the bar diagram. It will be possible to set a search profile (for example decreasing prices, unchanged volumes, progression in output-mix value) or define a search profile based on more specific values (like setting price increases to 10.0%, setting volume increases to at least 1% and selecting all negative bundle-mix, the profile of consumers on all product markets having witnessed a price increase of 10.0% and now compensating for price increases by selecting lower priced goods) and search the data accordingly, thereby finding product categories with probably increased as well as decreased sales performance depending on the extent of the adaptative behaviour of consumers (the extent to which consumers changed their product selection patterns) and thereby identifying products and categories or “markets” that could not have been selected by selecting only on “unchanged sales” or “decreased sales”. Or it will be possible to set a search value (prices decreasing by at least 5 percent). Visually the search for a given value or profile can be illustrated by setting all indicator “lights” to be of another colour, for example magenta whenever the indicator has the value searched for. Due to the definitions for calculating the three separate effects as proposed by the method a real innovative progress in data analysis is that the user is relieved from viewing or thumbing through the data to view patterns of sales or patterns of performance and pick interesting colour combinations. Instead the user can simply compute the search profile defined by the impact or effect on volume, prices and bundle-mix and the computer will process the data and pick and select the product or item groups listing these and listing as well the quantified results. Thereby the user can immediately pinpoint interesting behaviour and interesting groups or markets without viewing and browsing or clicking through extensive data. The process of viewing first a total and then browsing through the different groups and subgroups constituting this total is know as drilling down in the data in the terminology of data mining and by way of the method no thumbing through and visualising of data displayed graphically is necessary anymore, unless the user wants to just as the drilling down process instantly provides analytical results that assist in the comprehension of the causes for that result and are not limiting the user to viewing the results only.

The value of the indicators showing ΔQ, ΔP, ΔX and ΔY can also be shown each separately for all performance values of Y allowing the user to select less information and to thumb through visually and browse (or search using the search facility) selected indicators only.

In addition the surface area of the bar diagram is used as a platform to visualise the value for any (other than the three basic indicators, the volume effect, the price effect and the bundle-mix effect) explanatory variable or causal variable included in the data set. Just as for the indicator values, the operator can set a scale with a range and a colour scheme representing intervals or given values within this scale, the default being given as a set of three values, positive, 0, negative and three colours or a gradient of colour nuances within a monochrome scale.

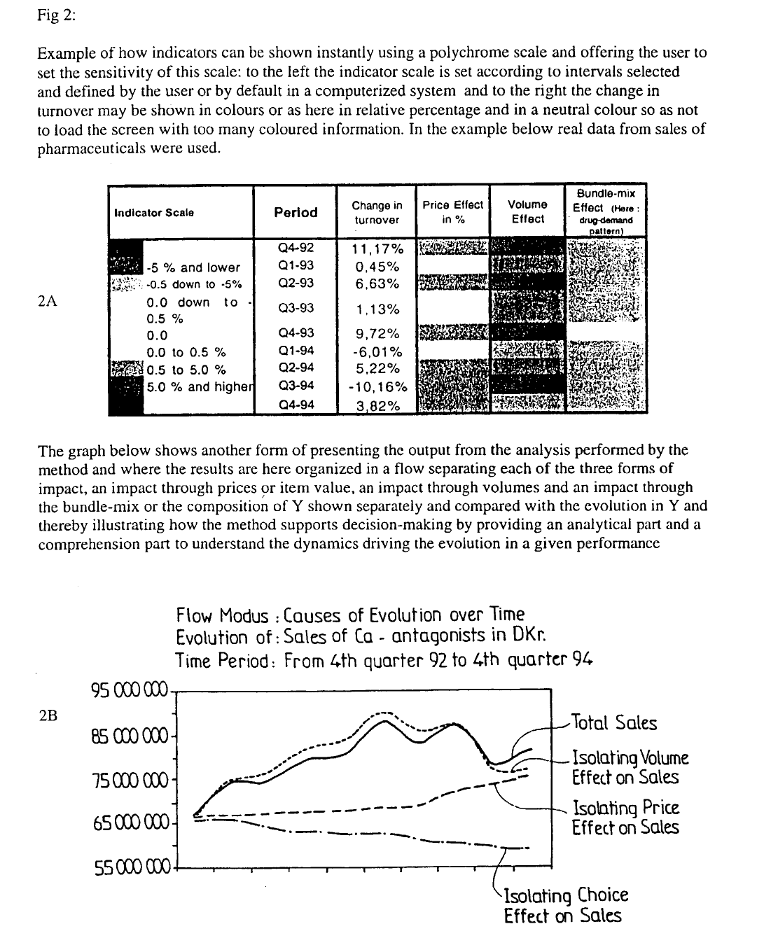

The interaction between the outcome variable and the three basic indicators can also be shown more traditionally as a graph like depicted in FIG. 2b to support the bar-diagram representation and to show the flow evolution in the three indicators as a time series. To the actual course taken by the outcome variable and the three indicators can be included the predicted or expected or desired course in the flow of the outcome and/or of any of the three indicators for the impact of prices, volume and bundle-mix, just as any other explanatory variable relevant to the context of the analysis and to the interpretation of results can be added and displayed graphically.

Then each indicator would have a separate colour graph line with the x-axis as the time axis and the indicator value (indexed to a base value) on the y-axis.

The visualisation of data also includes more traditional grid-viewing of data and a verbal text output stating the findings with facilities like a notepad and facilities to import the text into other applications and edit it for report writing to be added on choice and useful to the user as further support for browsing the bar-diagrams and for saving notes for a report. The verbal output will give out essential information as to the performance (the level in the Y dimension), difference between two or more measurements of performance variables, the value of the three basic indicators, if desired of the residual variable and a trend analysis. Additional information can be added depending on the further addition of other indicators typically more context specific indicators allowing to dig further into each category of impact represented by the three basic indicators, volume changes, price(or value per unit changes) and bundle-mix changes.

The outcome (performance) variable can be viewed in absolute mode, showing the value of the outcome (for example sales measured in dollars) for one period as compared to another period, and it can also be viewed in relative mode, showing only the increment from one period to another or the difference between one localisation and another, if a given unit is used as a reference unit for comparing the performance of other units. The whole set of indicators can also be viewed as flow variables showing the chain of incremental change having occurred on a baseline value for each period considered in the analysis.

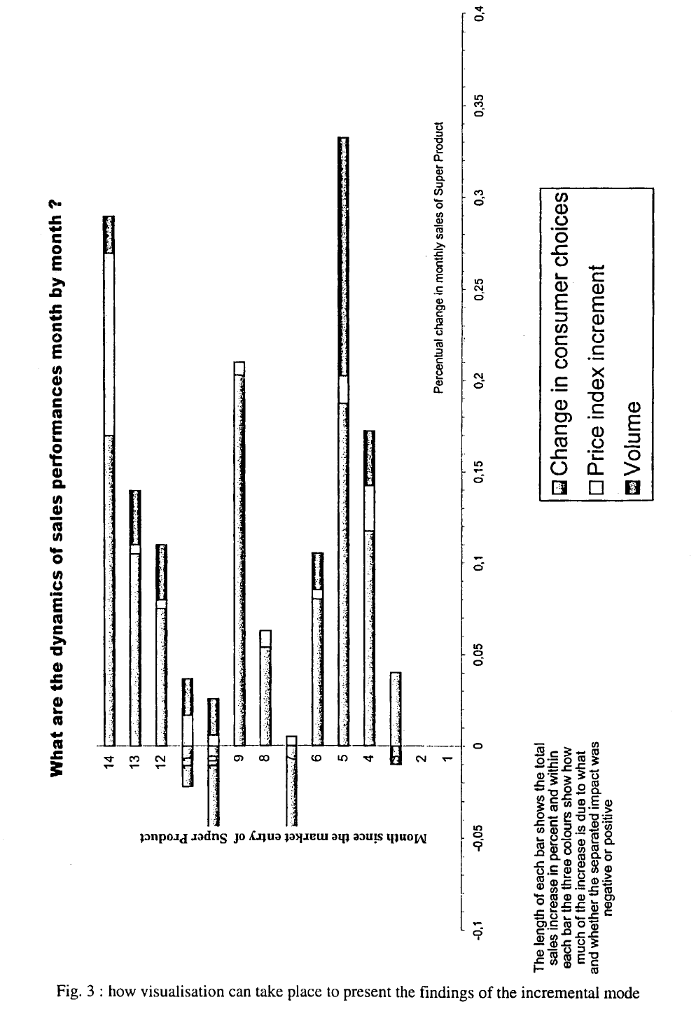

In the absolute mode, values will tend to normally always be 0 or positive ( in the absolute mode there will normally not be many cases recording negative performance in absolute terms like negative sales), and all bars can then be aligned to a baseline on the left. In the incremental mode, the baseline is the 0-value and bars could then run from the baseline to the right (positive) and from the baseline to the left (negative) if the baseline runs from top to bottom and the y-axis runs from left (negative) to right (positive). An example of visualisation and graphical display of the findings in the analysis performed in the incremental mode is shown in FIG. 3. In the flow mode (be it absolute flows showing for example sales in dollars during the last 10 years or relative flow mode showing the index value for the last 10 years) the most preferred visualisation will be a graph with different lines for the total performance (Y) and one for each of the three indicators, the price effect, the volume effect and the bundle-mix effect to which an additional line for example can be added like the expected evolution in Y (comparing the expected to the real evolution in Y and explaining it by way of the evolution in the three basic indicators) or by adding lines for the expected volume impact (and comparing it to the real volume evolution) or predicted prices (and comparing to the real evolution) or predicting shifting sales patterns or targeted sales pattern effect for example by way of actions like marketing and sales promotions (and comparing it to the real sales shifting pattern) which for example would allow instantly to monitor the effect of sales promotion on qualitative sales pattern and leave out sales boosters or sales cutbacks due to external and unexpected effects like seasonal effects affecting volumes in ways that are unrelated to sales promotion success or failure.

Similarly the visualisation like for example the fast review possible with the display mode in FIG. 1 or in FIG. 2 would allow fast reviewing, analysis and comprehension of complex situations encountered for example in the health sector when assessing the evolution of hospital costs and having to conduct cross-comparisons of otherwise not comparable departments like a ward for surgery and a ward for long-term geriatric care, the visualisation or the fast search would help instantly identify wards where costs increased due to higher volumes (more patients) and help separate from wards where costs increased because the patient mix (the composition of cases treated) changed unexpectedly with a higher proportion of heavy cases and separate again from wards where the total costs maybe remained unchanged in spite of falling volumes and due to invisible cost-gliding.

1. A method of analysing performance in the flow of items, the method comprising:
1) defining a first period of time starting at a first point in time and ending at a third point in time,
2) defining a second period of time starting at a fifth point in time and ending at a seventh point in time,
3) defining a group of items, identifying individual items, i, within the group,
4) defining a first market wherein the flow of the items, i, is analysed during the first period of time,
5) defining a second market wherein the flow of the items, i, is analysed during the second period of time,
6) determining, for each identified item, i, a first volume, qᵢ₀, and/or a turnover in monetary terms, yᵢ₀, transacted in the first market and during the first period of time,
7) determining, for each identified item, i, a second volume, qᵢ₁, and/or a turnover in monetary terms, yᵢ₁, transacted in the second market and during the second period of time,
8) determining, for each identified item, i, a price, pᵢ₀, thereof in the first market and within the first period of time,
9) determining, for each identified item, i, a price, pᵢ₁, thereof in the second market and within the second period of time,
10) providing information, Y₀, related to a total turnover in monetary terms of the items, i, in the first market and during the first period of time,
11) providing information, Y₁, related to a total turnover in monetary terms of the items, i, in the second market and during the second period of time,
12) providing information describing a difference, ΔY, in a transacted turnover for all items, i, from the first market during the first period of time to the second market during the second period of time,
13) providing information describing a difference, ΔQ, in a transacted volume for all items, i, from the first market during the first period of time to the second market during the second period of time,
14) estimating, on the basis of the determined pᵢ₀, pᵢ₁ and qᵢ₀, qᵢ₁, and/or yᵢ₀ and yᵢ₁, information, ΔP, describing a part of Y₁ which, compared to Y₀, stems from differences in prices of the items, i, from the first market and during the first period of time to the second market and during the second period of time,
15) providing to a user information relating to a difference between ΔY and a sum of ΔQ and ΔP.

2. A method according to claim 1, wherein step 15) comprises:
estimating, on the basis of the determined pᵢ₀, pᵢ₁ and qᵢ₀, qᵢ₁, and/or yᵢ₀ and yᵢ₁, information, ΔX, describing which part of Y₁ compared to Y₀, stems from a difference in the relative composition of Y as defined by the relative share of each individual item, i, from the first market and during the first period of time as compared to the second market and during the second period of time.

3. A method according to claim 1 or 2, wherein step 12) comprises determining ΔY as:
$$Δ Y = \frac{{Y}_{1} - {Y}_{0}}{{Y}_{0}}$$

4. A method according to any of the preceding claims, wherein step 13) comprises determining ΔQ as
$$Δ Q = \frac{{Q}_{1} - {Q}_{0}}{{Q}_{0}}$$
where Q₀ is the sum of all qᵢ₀ and Q₁ is the sum of all qᵢ₁.

5. A method according to any of the preceding claims, wherein step 14) comprises determining ΔP as ΔPₐ:
$$Δ {P}_{a} = \sum [ \frac{{p}_{i1} - {p}_{i0}}{{p}_{i0}} * {w}_{ai} ]$$
$$where {w}_{ai} = \frac{{q}_{i0}}{\sum {q}_{i0}}$$
and i=1, . . . n items contained in the item vector r

6. A method according to any of claims 1-4, wherein step 14) comprises determining ΔP as ΔPₚ:
$$Δ {P}_{p} = \sum [ \frac{{p}_{i1} - {p}_{i0}}{{p}_{i0}} * {w}_{pi} ]$$
$$where {w}_{pi} = \frac{{q}_{i1}}{\sum {q}_{i1}}$$
and i=1, . . . n items contained in the vector r

7. A method according to any of the preceding claims, wherein steps 6) and 8) comprise the steps of:
a) initially, at the first point in time, determining a price or item value for each identified item, i,
b) subsequently, at one or more second points in time when a change occurs in the group consisting of:
when a price of an item, i, changes,
when one of the items, i, is removed from the group,
when a new identified item, i, is introduced into the group,
when one of the items, i, is removed from the first market/location, and
when a new identified item, i, is introduced onto the first market/location, or
when specifications are changed, such as product contents, look, taste, usage, administration, standards,
b1) determining a price for all identified items, i, after the change,
b2) determining a turnover or performance value alternatively the transcted or transformed or consumed volume for each identified item, i, in the period from a previous second point in time or the first point in time to the actual, second point in time,
c) subsequent to step b) and at the third point in time, determining a price for all identified items, i, and a performance output for each identified item, i, on the period from the last second point in time to the third point in time.

8. A method according to any of the preceding claims, wherein steps 7) and 9) comprise the steps of:
a) initially, at the fifth point in time, determining a price for each identified item, i,
b) subsequently, at one or more sixth points in time when a change occurs in the group consisting of:
when a price of an item, i, changes,
when one of the items, i, is removed from the group,
when a new identified item, i, is introduced into the group,
when one of the items, i, is removed from the second market or location, and
when a new identified item, i, is introduced onto the second market or location, or
when specifications are changed, such as product contents, look, taste, usage, administration, standards,
b1) determining a price for all identified items, i, after the change,
b2) determining a turnover for each identified item, i, in the period from a previous sixth point in time or the fifth point in time to the actual, sixth point in time,
c) subsequent to step b) and at the seventh point in time, determining a price for all identified items, i, and a turnover for each identified item, i, on the period from the last sixth point in time to the seventh point in time.

9. A method according to claim 7 and/or 8, the method further comprising the step of: at each second and/or sixth point in time as well as at the third and seventh points in time determining the parameters:
ΔY, ΔQ, ΔP, ΔX,
and the parameter
υ=ΔY−ΔP−ΔQ−ΔX.

10. A method according to any of the preceding claims, wherein ΔX is calculated as
$$Δ Xa = \frac{100 * ( \sum {w}_{ai} * {Q}_{1} * {p}_{i1} ) - {Y}_{1}}{{Y}_{1}}$$
$$where {w}_{ai} = \frac{{q}_{i0}}{\sum {q}_{i0}}$$

11. A method according to any of claims 1-9, wherein ΔX is calculated as
$$Δ Xp = \frac{100 * ( \sum {w}_{pi} * {Q}_{0} * {p}_{i0} ) - {Y}_{0}}{{Y}_{0}}$$
$$where {w}_{pi} = \frac{{q}_{i1}}{\sum {q}_{i1}}$$

12. A method according to any of the preceding claims, wherein step 3) comprises defining a group of items and further defining one or more subgroups of items, where the items of the subgroups are comprised within the group of items.

13. A method according to claim 12, wherein steps 10)-15) comprise providing, for both the group as well as for any subgroups, the information Y₀ and Y₁ and the information describing the differences ΔY and ΔQ as well as estimating the information, ΔP and providing the information related to a difference between ΔY and the sum of ΔQ and ΔP.

14. A method according to any of the preceding claims, wherein step 3) comprises defining the group or one or more subgroups of items as (a) group(s) of items having in common:
the brand of the items,
the intended use of the items,
the contents of the items,
the same class and/or subclass in a standard global classification system for products and services fx. OTC,
the country of origin or manufacture of the items,
the region of origin or manufacture of the items,
the same producer/manufacturer/importer/exporter/retailer/wholesaler, and/or any criteria meaningful to the analysis and collected in the data and present as a dimension in the data set submitted for analysis.

15. A method according to claim 14, wherein step 3) further comprises defining a group or subgroup of items as items having in common:
the same number of units in a packing,
the same concentration of an active ingredient,
the same colour,
the same taste,
the same shape,
the same product standard,
the same dosage,
the same administration form,
the same intended use,
the same subsidy rate,
and/or any criteria meaningful to the analysis and collected in the data and present as a dimension in the data set submitted for analysis.

16. A method according to any of the preceding claims, the method comprising:
informing the user, if ΔX≠0, that changes in demand patterns were responsible for part of the difference between Y₁ and Y₀ and optionally to what extent as measured by ΔX and in the event of ΔX=0, checking by default or asking whether the user requires further check in the subgroups of the Y for which the calculations was performed and if no subgroups are defined checking at item level to report to the user the possibility of trends cancelling out each other and resulting in 0.

17. A method according to any of the preceding claims, the method comprising:
informing the user, if ΔP≠0, that changes in prices were responsible for part of the difference between Y₁ and Y₀ and optionally to what extent as measured by ΔP and in the event of ΔP=0, checking by default or asking whether the user requires further check in the subgroups of the Y for which the calculations was performed and if no subgroups are defined checking at item level to report to the user the possibility of trends cancelling out each other and resulting in 0.

18. A method according to any of the preceding claims, the method comprising:
informing the user, if ΔQ≠0, that changes in volumes were responsible for part of the difference between Y₁ and Y₀ and optionally to what extent as measured by ΔQ and in the event of ΔP=0, checking by default or asking whether the user requires further check in the subgroups of the Y for which the calculations was performed and if no subgroups are defined checking at item level to report to the user the possibility of trends cancelling out each other and resulting in 0.

19. A method according to any of the preceding claims, wherein steps 1), 2), 4), and 5) comprise defining at least substantially coinciding periods of time and first and second markets or place of performance which differ for example in the locational or in other dimensions as the intended usage of a product or the target group or other dimensions.

20. A method according to any of claims 1-16, wherein 1), 2), 4), and 5) comprise defining different periods of time and at least substantially identical markets.

21. A method according to any of the preceding claims, further comprising the step of illustrating visually information related to ΔP, ΔQ and ΔX, and ΔY and y₀ and y₁, as well as other dimensions of the data set.

22. A method according to claim 21, wherein the indicator values are visualised by graphical means such as a 3D bar diagram where the length of each bar reflects the turnover of that item or that group in period y, and for each bar a set of 4 buttons displaying the indicator value illustrating the value for each item or group of ΔY, ΔP, ΔQ and ΔX is displayed

23. A method according to claim 21 or 22, wherein the intervals of the product mix index is graphically shown as a colour of the graphical means, so that a colour complies to a interval, such as choosing for example a duo-chrome scale with red for positive and blue for negative values, for high positive values of ΔX the brighter red the colour and for low negative values (high numerical value but below 0) the darker blue the colour.

24. A method of simulating item flow, the method comprising performing the method according to claim 1, wherein steps 6)-9) comprise providing expected future prices or item values and/or volumes and/or composition of Y in terms of items entering into Y and/or performance output.

25. A method according to claim 24, wherein the expected future prices or item values and volumes and composition of Y in terms of items entering, into Y and/or performances are real, determined prices and volumes and composition at item level and/or turnovers which are transformed to represent the expected future prices and volumes and/or turnovers.

26. A method of monitoring item flow, the method comprising the method according to claim 1 and the further steps of:
establishing a desired development for at least one of Y1, Y2, ΔX, ΔY, ΔP, and/or ΔQ, and/or at the level of y₁, y₂, ΔY, ΔP, ΔQ (item level)
automating the process of informing a user or operator if this development is not followed together with information as to the extent and coordinates of the deviation.

27. A computer system performing the method according to any of the preceding claims.

28. A computer program comprising computer program code means adapted to perform all the steps of claim 1

29. A computer program comprising computer program code means adapted to perform all the steps of claim 21 , 22 and 23 to support the visualisation when said program is run on a computer.

30. A computer program according to claim 28 and claim 29 embodied on a computer readable medium.
